(19) United States
(12) Patent Application Publication
(10) Pub. No.: US 2018/0045893 A1
(43) Pub. Date: Feb. 15, 2018

(54) INTEGRATED OPTICAL SWITCHING AND SPLITTING FOR OPTICAL NETWORKS

(71) Applicant: CommScope Connectivity Belgium BVBA, Kessel-Lo (BE)

(72) Inventors: Koen HUYBRECHTS, Heverlee (BE); Jan WATTE, Grimbergen (BE); Cristina LERMA ARCE, Gentbrugge (BE)

(73) Assignee: CommScope Connectivity Belgium BVBA, Kessel-Lo (BE)

(21) Appl. No.: 15/537,278

(22) PCT Filed: Dec. 18, 2015
(86) PCT No.: PCT/EP2015/080617

§ 371 Date: Jun. 16, 2017

Related U.S. Application Data
(60) Provisional application No. 62/094,506, filed on Dec. 19, 2014.

(51) Int. Cl. G02B 6/35; H04B 10/071; H04Q 11/00; G02B 6/125; G02B 6/12

(52) U.S. Cl. CPC G02B 6/3538; G02B 6/3596; G02B 6/125; G02B 6/3594; G02B 6/12007; G02B 6/3546; H04Q 11/0005; G02B 6/3568; H04Q 11/0062; H04B 10/071; G02B 2006/1215; G02B 2006/12145; H04Q 2011/0035; H04Q 2011/0083

(57) ABSTRACT

Integrated optical devices include various configurations of active optical switches and other passive components such as splitters that are useful for controlling signals in optical data transmission networks. An optical switch may be used to switch light between waveguides on different substrates. The active optical switch may include one or more microfluidic droplets that are controllably movable relative to the coupling region to change the amount of light couplable between the first and second switch waveguides. Different configurations of the droplets can be controlled for operating the switch in different switching states. An optical switch can be included in an end use transceiver device for remotely controlling an optical time domain measurement. A microfluidic switch can be used to control wavelength-selective reflection in a waveguide reflector.

### CROSS-REFERENCE TO RELATED APPLICATION

This application claims the benefit of U.S. Patent Application Ser. No. 62/094,506, filed on Dec. 19, 2014, the disclosure of which is incorporated herein by reference in its entirety.

### BACKGROUND

The present invention is generally directed to optical transmission networks, and more particularly to systems that permit flexible configuration of optical components in the field.

Passive optical networks are becoming prevalent in part because service providers want to deliver high bandwidth communication capabilities to customers. Passive optical networks are a desirable choice for delivering high-speed communication data because they may not employ active electronic devices, such as amplifiers and repeaters, between a central office and a subscriber termination. The absence of active electronic devices may decrease network complexity and/or cost and may increase network reliability.

FIG. 1 illustrates one embodiment of a network 100 deploying fiber optic lines. In the illustrated embodiment, the network 100 can include a central office 101 that connects a number of end subscribers 105 (also called end users 105 herein) in a network. The central office 101 can additionally connect to a larger network such as the Internet (not shown) and a public switched telephone network (PSTN). The network 100 can also include fiber distribution hubs (FDHs) 103 that distribute signals to the end users 105. The various lines of the network 100 can be aerial or housed within underground conduits.

The portion of the network 100 that is closest to central office 101 is generally referred to as the F1 region, where F1 is the “feeder fiber” from the central office 101. The portion of the network 100 closest to the end users 105 can be referred to as an F2 portion of network 100. The network 100 includes a plurality of break-out locations 102 at which branch cables are separated out from the main cable lines. Branch cables are often connected to drop terminals 104 that include connector interfaces for facilitating coupling of the fibers of the branch cables to a plurality of different subscriber locations 105.

FDHs receive signals fiber distribution hubs may include and input fiber that receives an incoming signal from the central office 101. The incoming signal may then be split at the FDH 103, using one or more optical splitters (e.g., 1×8 splitters, 1×16 splitters, or 1×32 splitters) to generate different user signals that are directed to the individual end users 105. In typical applications, an optical splitter is provided prepackaged in an optical splitter module housing and provided with a splitter output in pigtails that extend from the module. The optical splitter module provides protective packaging for the optical splitter components in the housing and thus provides for easy handling for otherwise fragile splitter components. This modular approach allows optical splitter modules to be added incrementally to FDHs 103 as required.

The number of end users may change, however, for example through the addition of new customers to the network or by customers dropping out of the network, and so occasions arise where the splitter in the FDH 103 may need to be replaced. In the case where more customers are added to the network, a splitter may need to be replaced by one having more outputs, for example a 1×16 splitter may need replacing by a 1×32 splitter. In other situations, for example where the number of customers drops, it may be useful to replace a splitter with one having fewer outputs. The replacement of a splitter at an FDH 103 requires that a technician travel to the FDH 103 to physically swap out the splitter. This can be costly and time-consuming. Also, a technician visit may be necessary when taking other actions, such as switching over to more OLTs when the number of customers increases, or when switching users between different service levels, such as different bitrates or video channels.

Furthermore, the splitters that are conventionally used in optical networks are passive devices whose configuration cannot be changed, which can lead to difficulties in monitoring the performance of the optical network. For example, one way of tracking down the cause of a signal loss at one or more end users is to use optical time-domain reflectometry (OTDR), which involves transmitting a pulsed optical signal along the fiber. Breaks, cracks or other issues with the fiber can result in a portion of the optical pulse being reflected to the source of optical pulses. The arrival times of the reflected pulses can be recorded and the time-of-flight measurement can be correlated with the position in the fiber where the reflection occurred. If there is a problem with transmission of signals to a particular end user, a technician has to set up the OTDR equipment downstream of the splitter output in the FDH 103 in order to isolate the end user's fiber from other fibers. This requires that the technician travels to the FDH 103 and physically disconnects the end user's fiber from the splitter in order to initiate the OTDR measurements. Again, this can be costly and time-consuming

Therefore, there is a need for remote access to the FDH for changing the configuration of the splitter to add or drop fibers to end users, or to reconfigure the optical network to allow monitoring of one or more end users' fibers.

### SUMMARY

According to some embodiments of the invention, an optical device has a waveguide splitter cascade comprising at least first and second tiers of waveguide splitter nodes. Each waveguide splitter node has a respective input waveguide coupled to two respective output waveguides. At least one output waveguide of the first tier of waveguide splitters comprises an input waveguide of a waveguide splitter of the second tier of waveguide splitters. An active optical switch having two or more inputs and an output is connected as an input to one of the waveguide splitter nodes.

According to other embodiments of the invention, an active optical switch device includes a first switch waveguide, a second switch waveguide and a coupling region formed between the first and second switch waveguides for coupling light between the first and second switch waveguides. One or more microfluidic droplets are controllably movable relative to the coupling region to change the amount of light couplable between the first and second switch waveguides. A first configuration of the one or more microfluidic droplets corresponds to a minimum level of optical coupling between the first and second switch waveguides. A second configuration of the one or more microfluidic droplets corresponds to a maximum level of optical coupling between the first and second switch waveguides, while at least a third configuration of the one or more microfluidic droplets corresponds to at least an intermediate level of optical coupling between the first and second switch waveguides.

According to another embodiment of the invention, an active optical switch device includes a first switch waveguide supported on a first substrate that has a first optical circuit and a second switch waveguide supported on a second substrate that has a second optical circuit. A coupling region is formed between the first and second switch waveguides for coupling light between the first and second switch waveguides. One or more microfluidic droplets are controllably movable relative to the coupling region to change the amount of light couplable between the first and second switch waveguides.

According to another embodiment of the invention, an optical device includes a first active optical switch having a first waveguide and a second waveguide. A first coupling region is formed between the first and second waveguides for coupling light between the first and second waveguides. At least one microfluidic droplet is controllably movable relative to the first coupling region. The optical device also has a second active optical switch that includes the first waveguide and a third waveguide. A second coupling region is formed between the first and third waveguides for coupling light between the first and third waveguides. At least one microfluidic droplet is controllably movable relative to the second coupling region. The optical device also has a third active optical switch that includes the second waveguide and a fourth waveguide. A third coupling region is formed between the second and fourth waveguides for coupling light between the second and fourth waveguides. At least one microfluidic droplet is controllably movable relative to the third coupling region.

Other embodiments of the invention include an end user optical transceiver device that includes an input waveguide coupled to receive optical data transmitted from a fiber distribution hub and a transceiver unit coupled to receive an optical signal from the input waveguide. A second waveguide is coupled to a waveguide reflector that reflects light at a wavelength of light received at the input waveguide. An optical switch is located at a coupling region between the input and second waveguides to selectively switch light from the input waveguide to the waveguide reflector.

Other embodiments of the invention are directed to a switchable, wavelength-dependent optical device that includes a first waveguide couplable to receive an optical signal at at least a first wavelength and a second wavelength. A wavelength selective reflector on the first waveguide transmits light within the first waveguide at the first wavelength, in a first reflective state, reflects light within the waveguide at the second wavelength, and in a second reflective state transmits light within the waveguide at the second wavelength. A microfluidic arrangement is configured to control the reflective state of the wavelength selective reflector.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates various elements of an optical data distribution and communication network;

FIG. 2 schematically illustrates an embodiment of elements of a fiber distribution hub according to an embodiment of the present invention;

FIGS. 3A-3D schematically illustrate switched optical splitters according to embodiments of the present invention;

FIGS. 4A-4D schematically illustrate switched optical circuits according to additional embodiments of the present invention;

FIGS. 5A-5B schematically illustrate an optical switch according to an embodiment of the present invention;

FIGS. 6A-6C schematically illustrate an optical switch according to another embodiment of the present invention;

FIGS. 7A-7D schematically illustrate an optical switch according to another embodiment of the present invention;

FIGS. 8A-8D schematically illustrate an optical switch according to another embodiment of the present invention;

FIGS. 9A-9B schematically illustrate an optical switch according to another embodiment of the present invention;

FIGS. 10A-10B schematically illustrate an optical switch according to another embodiment of the present invention;

FIG. 11 schematically illustrates an optical circuit that includes two optical switches in series according to an embodiment of the present invention;

FIGS. 12A-12B schematically illustrate an optical circuit that includes two optical switches in series according to another embodiment of the present invention;

FIGS. 13A-13B schematically illustrate a two layer optical circuit according to another embodiment of the present invention;

FIG. 14 schematically illustrates part of an optical network using optical switches according to an embodiment of the present invention;

FIGS. 15A-15B schematically illustrate a wavelength selective switch according to an embodiment of the present invention; and

FIGS. 16A-16B schematically illustrate a wavelength selective switch according to another embodiment of the present invention.

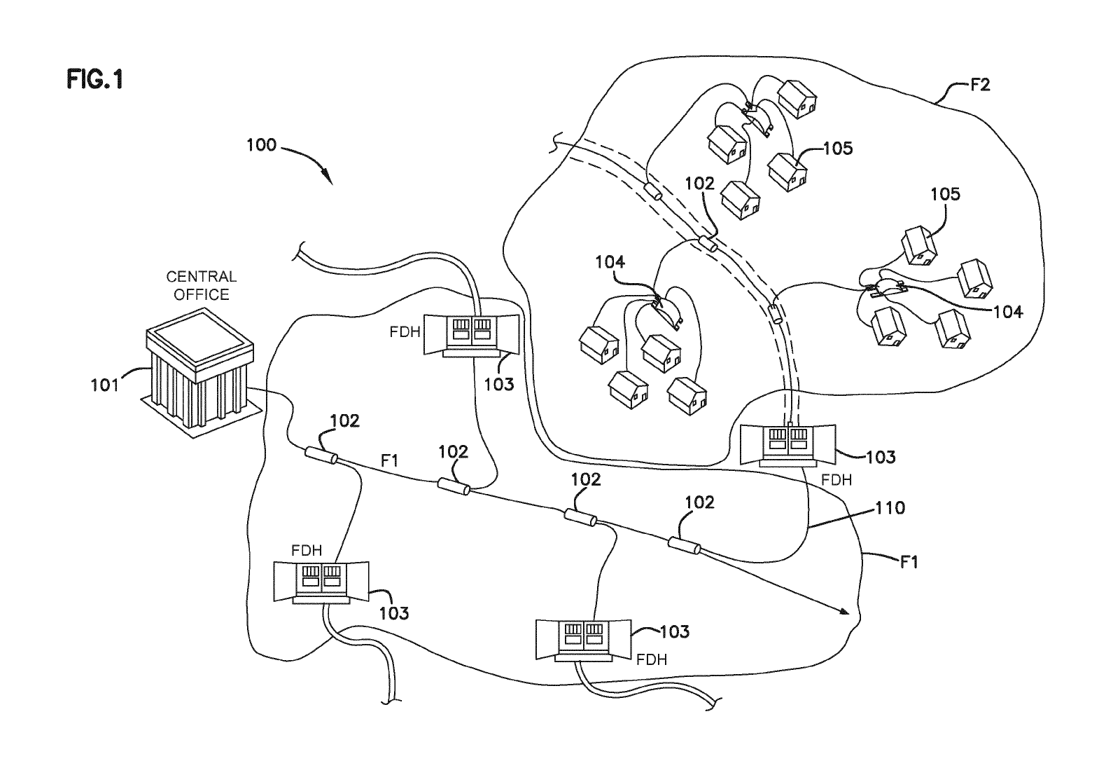

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed to various optical devices and systems that can provide benefit in optical networks by providing for remote configuration, thus reducing the need for technician visits to a fiber distribution hub (FDH) and allowing various operations to be carried out more quickly than using conventional passive optical components.

In an illustrated embodiment of the invention, the optical network 100 includes a cable 110 that connects to an FDH 103. The cable 110 includes at least an optical data transmission fiber and an FDH control channel, which may be optical or electrical.

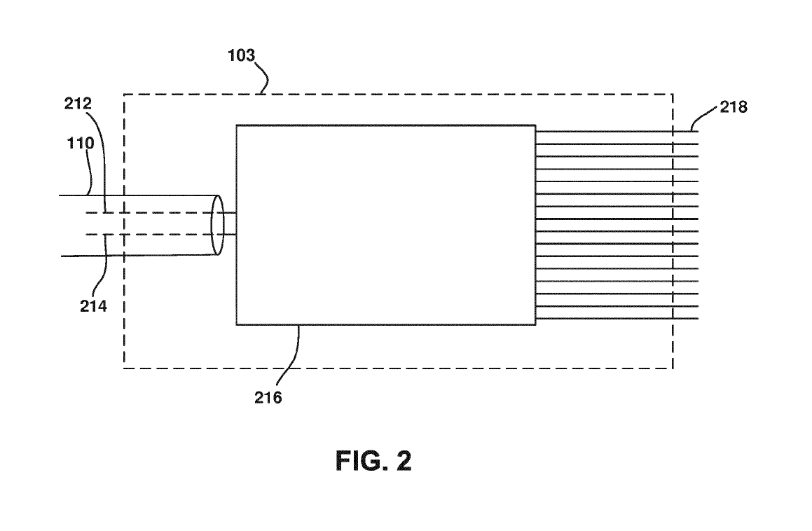

An illustrated embodiment of the FDH 103 and cable 110 are seen in greater detail in FIG. 2. The cable 110 entering the FDH 103 includes an optical data channel 212 and an FDH control channel 214. The optical data channel is typically one or more optical fibers and may include optical data transmission, such as cable television signals which are typically unidirectional in the fiber, and optical communications, for example internet traffic which are typically bidirectional in the fiber. The control channel 214 provides a control signal to the optical circuit 216 located within the FDH 103. The optical circuit 216 contains any optical elements that are used in the FDH 103 to distribute an optical signal to the end users 105. For example, the optical circuit may contain one or more optical splitters, optical switches, amplifiers, optical circulators, multiplexers, and other such elements that are typically used in optical data transmission networks. In the illustrated embodiment, the optical circuit 216 includes one or more splitters so that the optical signal is split into a number of different output channels 218 that are fed to end users 105. The output channels 218 may be optical channels, such as optical fibers, or may be electrical channels, for example coaxial electrical cables. In the case where the output channels 218 are electrical channels, the optical circuit 216 may also include optical-electrical converters for data transmission.

According to an embodiment of the present invention the optical circuit 216 includes one or more remotely-controlled active optical elements that may be used, for example, to change the configuration of the optical circuit or the ratio of signal split into different output channels. Different approaches may be used to provide active control of the optical signals within the optical circuit 216 including, for example microfluidic, micromechanical (e.g. MEMS), and electro-optic. An advantage of the microfluidic and micromechanical approaches over an electro-optical approach is that a microfluidically-controlled optical circuit can be manufactured on a glass substrate, which is relatively inexpensive, whereas the electro-optical approach requires the use of electro-optic crystals are more expensive than glass. A remotely-controllable optical circuit (RCOC) may, for example include one or more switches that can change a splitter from a configuration having a first number of outputs to a splitter having a second number of outputs. In another example of an RCOC, an optical switch is able to provide multiple levels of coupling between two waveguides, thus allowing a user to control the amount of light that is coupled from one waveguide into one or more other waveguides. The following description provides some examples of RCOCs that may be incorporated in an FDH.

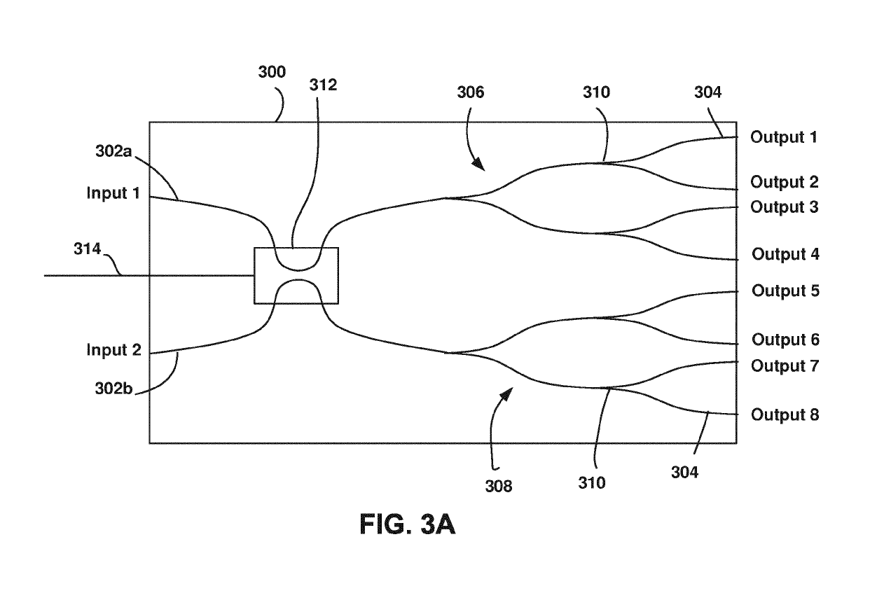

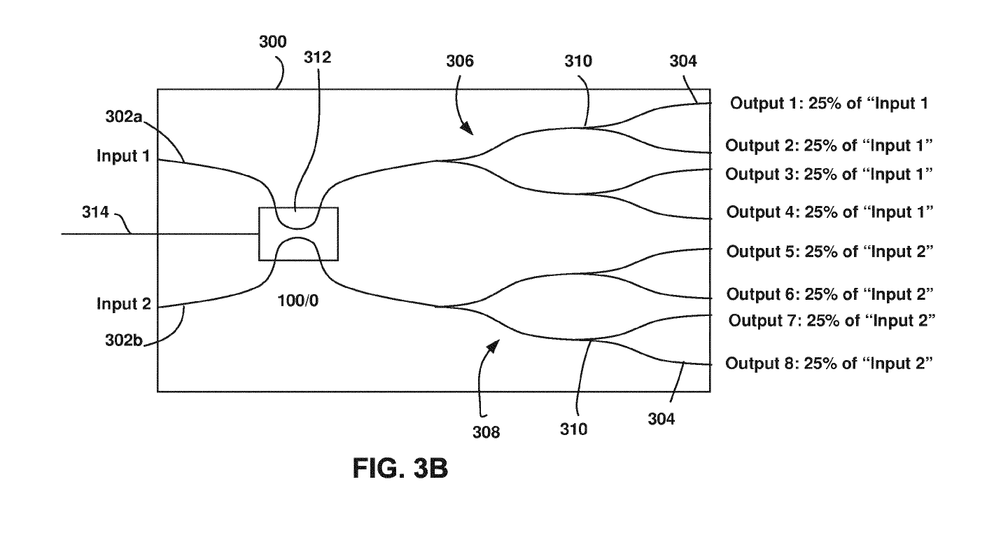

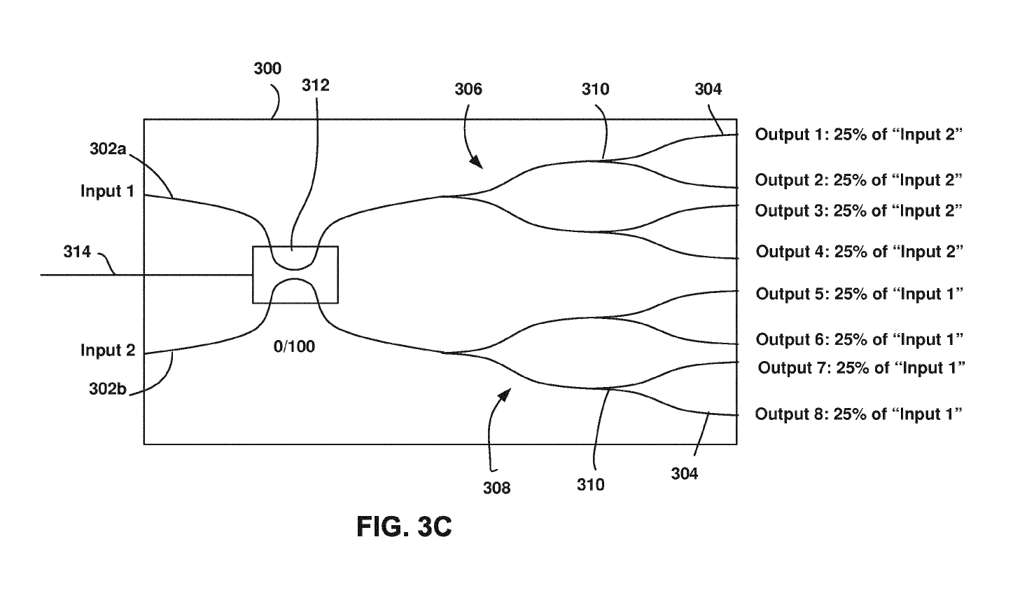

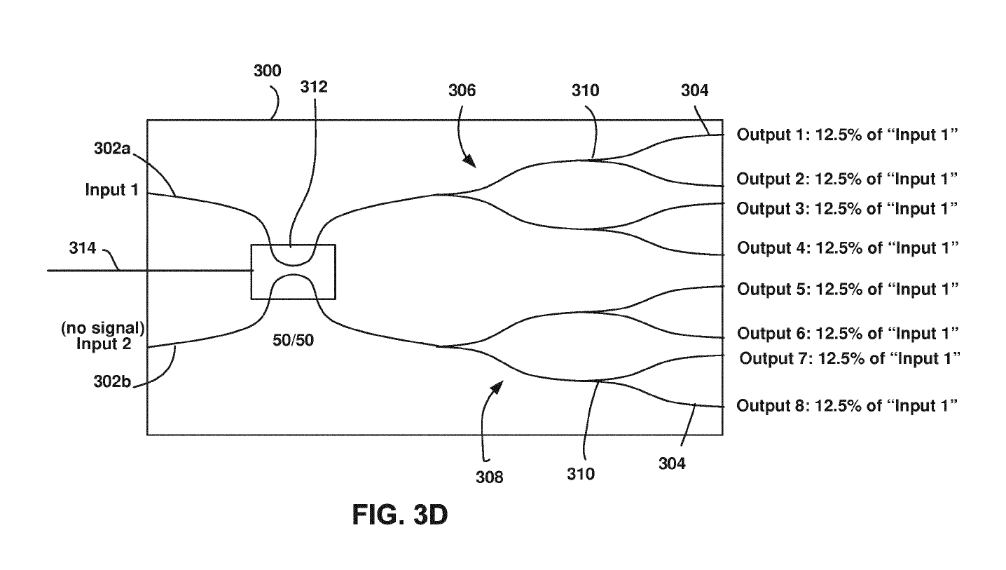

A first exemplary embodiment of an RCOC 300 is schematically illustrated in FIG. 3A. The RCOC 300 includes first and second input waveguides 302a and 302b, labeled Input 1 and Input 2 respectively, and has eight outputs 304, labeled Output 1-Output 8. Outputs 1-4 are directly connected to Input 1 via a first splitting network 306 and Outputs 5-8 are directly connected to Input 2 via a second splitting network 308. In many cases, the splitting networks 306, 308 may include a number of symmetric splitting nodes 310 that split the input optical power into two equally powered outputs, although this need not be the case and some of the splitting nodes 310 may be asymmetric, with more of the incoming optical power being directed to one of its outputs than the other. A splitting node 310 includes one input waveguide that splits into two output waveguides.

An optical switch 312 is positioned to allow coupling of light between Input 1 and Input 2. The optical switch may be, for example, microfluidic, micromechanical or electro-optical. In some embodiments the optical switch 312 may be adjustable between only two switching states and in other embodiments the optical switch may be adjustable over a number of switching states. The term “switching state” refers to the amount of light coupled between waveguide 302a and 302b in the switch 312. Thus, in a first switching state a first amount of light is coupled between the waveguides 302a, 302b. In a second switching state, a second amount of light is coupled between the waveguides. In some cases, a two-state optical switch will have a “bar state”, in which non light is coupled between the waveguides and a “cross state” in which approximately 100% of the light is coupled between the waveguides. A control signal may be applied to the switch 312 via a control channel 314. The control signal on control channel 314 may be optical or electrical. In the illustrated embodiment the splitting nodes 310 are arranged in two tiers, with the first tier including the nodes 310 immediately following the switch 312, splitting from two to four waveguides and a second tier of nodes 310 splitting from four to eight waveguides.

In one configuration of the RCOC 300, schematically illustrated in FIG. 3B, the switch 312 is in the so-called “bar state,” in which 100% of the light traveling along a waveguide remains in that waveguide and 0% of the light is coupled into the other waveguide. In FIGS. 3B-3D, the two numbers below the switch correspond to the percent amount transmitted along a waveguide without coupling and to the percent amount coupled between the waveguides. Thus, the number 100/0 means that 100% of the light is transmitted along the respective waveguide and no light is coupled to the other waveguide. Thus, in the embodiment illustrated in FIG. 3B substantially all the light entering Input 1 is transmitted to Outputs 1-4 and substantially all the light entering Input 2 is directed to Outputs 5-8. In this embodiment it has been assumed that all the splitter nodes 310 are symmetrical, so the light from Input 1 is split equally among outputs 1-4 and the light from Input 2 is split equally among Outputs 5-8. Of course, it will be appreciated that one or more of the splitter nodes 310 may be asymmetrical in this embodiment or in other embodiments discussed below.

In another configuration of the RCOC 300, schematically illustrated in FIG. 3C, the switch 312 is in a so-called “cross-state,” in which 100% of the light travelling along a waveguide is coupled to the other waveguide. This configuration may be referred to as 0/100. Thus, substantially all the light entering Input 1 is coupled over to the second splitting network 308 and transmitted to Outputs 5-8, while substantially all the light entering Input 2 is coupled over to the first splitting network 306 and transmitted to Outputs 1-4.

In another configuration of the RCOC 300, schematically illustrated in FIG. 3D, the switch 312 is in an intermediate state, in which some light is transmitted along the waveguide and some is coupled to the other waveguide. In the illustrated embodiment 50% of the light travelling along a waveguide is coupled to the other waveguide. This configuration may be referred to as 50/50. Thus, 50% of the light entering Input 1 is transmitted to the first splitting network 306 and 50% is coupled over to the second splitting network 308 and transmitted to Outputs 5-8. If no signal is applied to Input 2, then Outputs 1-8 all transmit a fraction of the signal applied to Input 1. Where the splitting nodes 310 are all symmetrical, each output contains about 12.5% of the light signal applied at Input 1 (ignoring losses). In this 50/50 configuration, the RCOC 300 acts as a 2×8 splitter, whereas the RCOC 300 configurations shown in FIGS. 3B and 3C act as two 1×4 splitters.

Input 2 may also be used to inject a signal into the RCOC 300, for example at a different wavelength from that injected into input 1, as might be used for the simultaneous transmission of a video signal and a data signal or a network test signal. In the illustrated embodiment, with the switch 312 in a 50/50 configuration, light injected at input 2, as well as light injected at input 1, is spread evenly among all outputs.

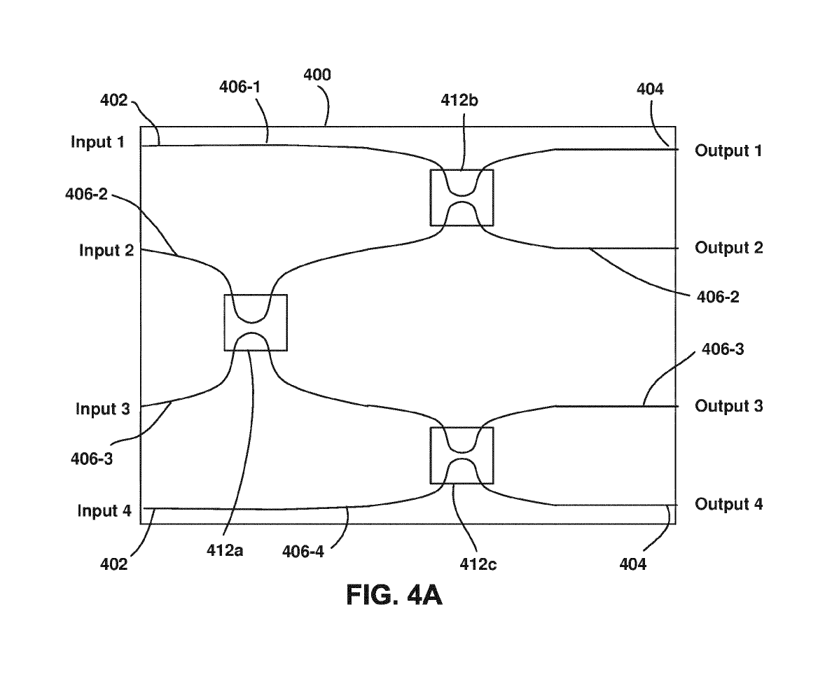

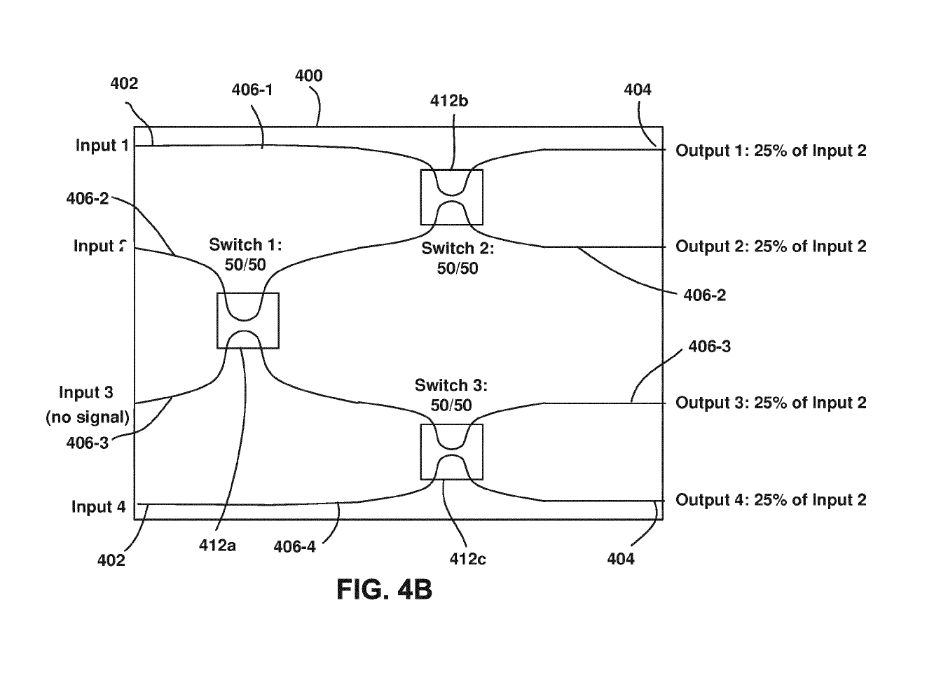

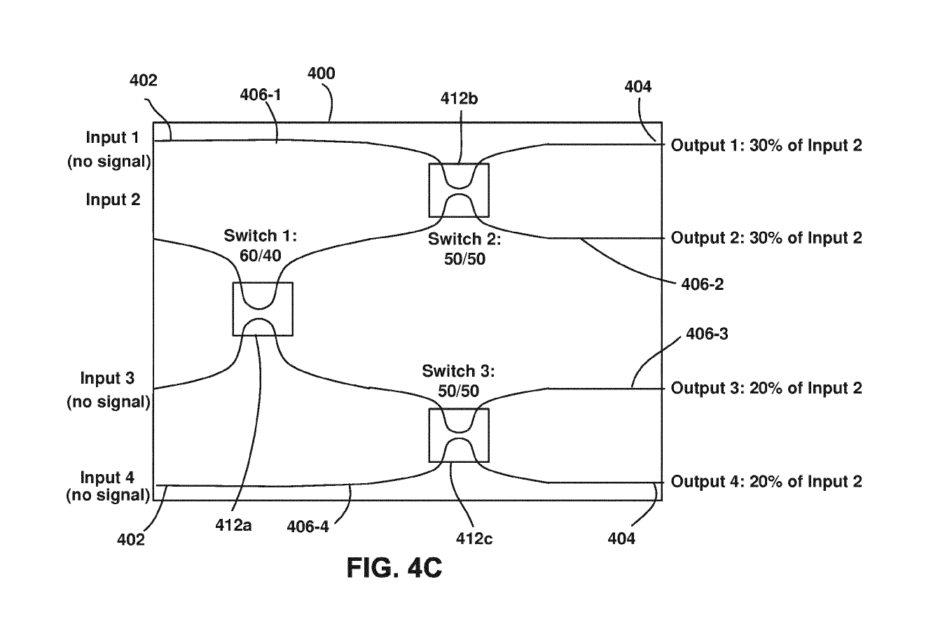

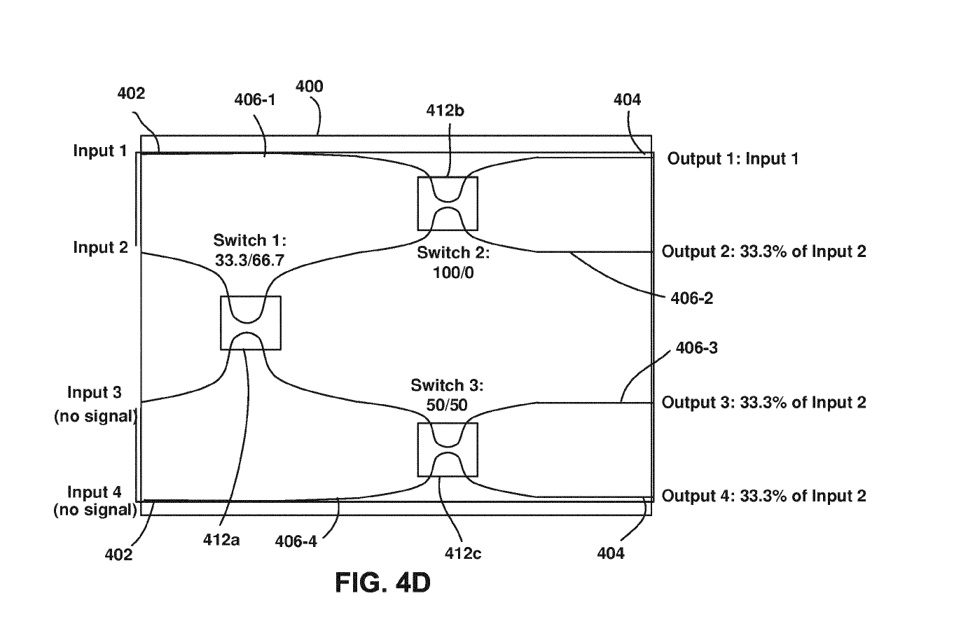

Another exemplary embodiment of a RCOC 400 is schematically illustrated in FIG. 4A. The RCOC 400 has four inputs 402, labelled Input 1-Input 4 and four outputs 404, labelled Output 1-Output 4. Output 1 is directly connected along a waveguide 406-1 to Input 1, and likewise Outputs 404 are directly connected along waveguides 406-2-406-4 to Inputs 2-4, respectively. In this embodiment, a first optical switch 412a is positioned to couple light between the second and third waveguides 406-2 and 406-3. Also, downstream of the first optical switch 412a, a second optical switch 412b is positioned to couple light between the first and second waveguides 406-1 and 406-2, and a third optical switch 412c is positioned to couple light between the third and fourth waveguides 406-3 and 406-4.

The configurations of the switches 412a-412c may be selected to determine different output conditions from the RCOC 400. For example, if all three switches 412a-412c are in the 100/0 configuration, then no light is coupled from one waveguide to another, and so the signal at Output 1 is simply the input signal at Input 1, and the signals at Outputs 2-4 are the respective signals at Inputs 2-4.

In another configuration, schematically illustrated in FIG. 4B the switches 412a-412c are set as 50/50 switches. Thus a signal at Input 2 is split equally between the second and third waveguides 406-2 and 406-3. The signal propagating along the second waveguide 406-2 to the second switch 412b is again split equally into two signals respectively propagating along waveguides 406-1 and 406-2 to Outputs 1 and 2. Likewise, the signal propagating along the third waveguide 406-3 to the third switch 412c is split equally into two signals respectively propagating along waveguides 406-3 and 406-4 to Outputs 3 and 4. Thus, the reconfiguration of the switches 412a-412c as 50/50 switches results in the RCOC 400 operating as a 1×4 splitter, splitting the signal at Input 2 equally into four output signals at Outputs 1-4. It will be appreciated that the switch configuration illustrated in FIG. 4B will also lead to the RCOC operating as a 1×4 splitter for signals applied at Input 3.

In some configurations there may be no signal on Inputs 1, 3 and/or 4. In other configurations, there may be input signals present at any combination of Inputs 1-4. For example, a configuration with an input signal applied to at Input 2 and an input signal applied to Inputs 1 and/or 4, may be useful where the signal on Input 2 can undergo more splitting than the signal(s) on Inputs 1 and/or 4, e.g. a video broadcast signal at 1550 nm is input at Input 2 and data signals at 1310 nm/1490 nm are input to Inputs 1 and/or 4.

Another configuration is schematically illustrated in FIG. 4C. This configuration is similar to that described above for FIG. 4B, except that the first switch 412a is set as a 60/40 switch, with the result that Outputs 1 and 2 each transmit a signal of 30% of the signal at Input 2, whereas Outputs 3 and 4 each transmit a signal of 20% of the signal at Input 2. Such a configuration may be useful, for example, where the end users who receive signals from Outputs 1 and 2 are located at a greater distance from the FDH than the users who receive signals from Outputs 3 and 4, and are therefore subject to greater signal transmission losses. It will be appreciated that the switching ratios of each of the switches 412a-412c may be adjusted to achieve any particular desired balance in the magnitude of signals at Outputs 1-4, for example to account for downstream transmission losses in a situation where it is desirable for each end user to receive a signal of the same magnitude.

In another configuration, schematically illustrated in FIG. 4D, the first switch 412a is set as a 33.3/66.7 switch, so that one third of the signal at Input 2 propagates along the second waveguide 406-2 to the second switch 412b and two thirds of the signal propagates along the third waveguide 406-3 to the third switch 412c. The third switch 412c is set as a 50/50 switch, so that half of the signal entering the third switch 412c is transmitted to Output 3 and the other half is transmitted to Output 4. The second switch 412b is set as a 100/0 switch, so that all of the signal reaching the second switch 412b from the first switch 412a is transmitted to Output 2. In this manner, the signals at Outputs 2-4 are each ⅓ of the signal input at Input 2. Thus, in this configuration, the RCOC 400 operates as a 1×3 splitter. Since the second switch 412b is set as a 100/0 switch, all of the signal at Input 1 propagates to Output 2, thus permitting point-to-point communications between a first user coupled to Input 1 and a second user coupled to Output 1.

It will be appreciated that the RCOC may operate differently under other configurations of the switches. For example, in the case where the first switch 412a is set as a 100/0 switch and the second and third switches 412b, 412c are each set as 50/50 switches, the RCOC operates as two 1×2 splitters. Thus, Outputs 1 and 2 will each receive 50% of a signal input at Input 1 (or Input 2) while Outputs 3 and 4 will each receive 50% of the signal at Input 3 (or Input 4). Furthermore, the second and third switches 412b and 412c may be set to provide for asymmetric division of optical signals. For example, the second switch 412b may be set for a 33.3/66.7 switching ratio.

One approach to implementing an optical switch having multiple switching states is to use a microfluidic optical switch. Microfluidic switches are generally based on changing the effective refractive index experienced by light propagating within a waveguide. This can be achieved, for example, by moving a droplet of liquid of a first refractive index liquid surrounded by a liquid of a second refractive index liquid in microfluid channels disposed close to waveguides. Examples of microfluidic switches are described in C. Lerma Arce et al. “Silicon Photonic Sensors Incorporated in a Digital Microfluidic System,” Analytical and Bioanalytical Chemistry, 404(10) 2887-94 (2012) and C. Lerma Arce, PhD Thesis: “Novel Microfluidic Platforms Incorporating Photonic Ring Resonator Sensors,” Photonics Research Group, INTEC University of Gent, 2014, and U.S. Pat. No. 7,283,696, incorporated herein by reference. The microfluidic change in the effective refractive index can affect the coupling coefficient between a waveguide along which the light is propagating and a neighboring waveguide. Thus, it is possible to microfluidically control the coupling coefficient and, therefore, the amount of light propagating along the two waveguides.

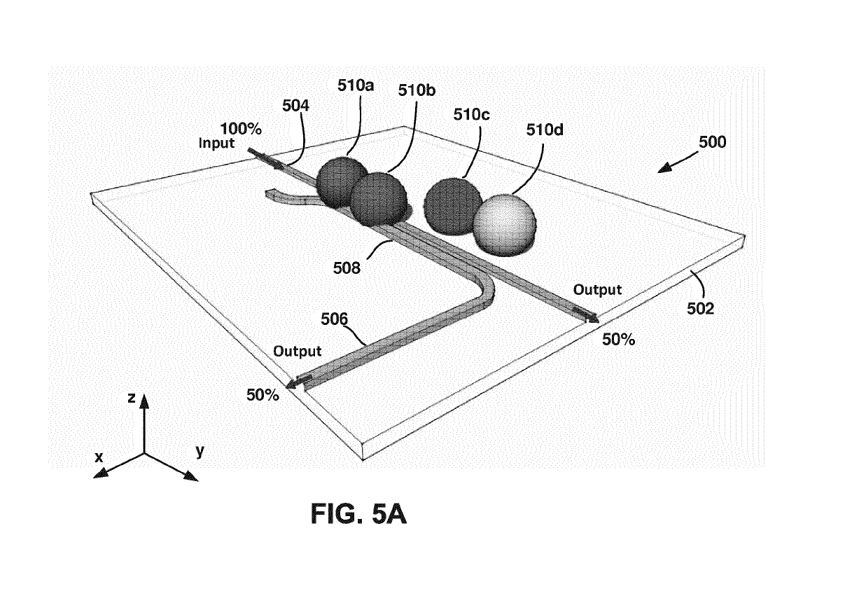

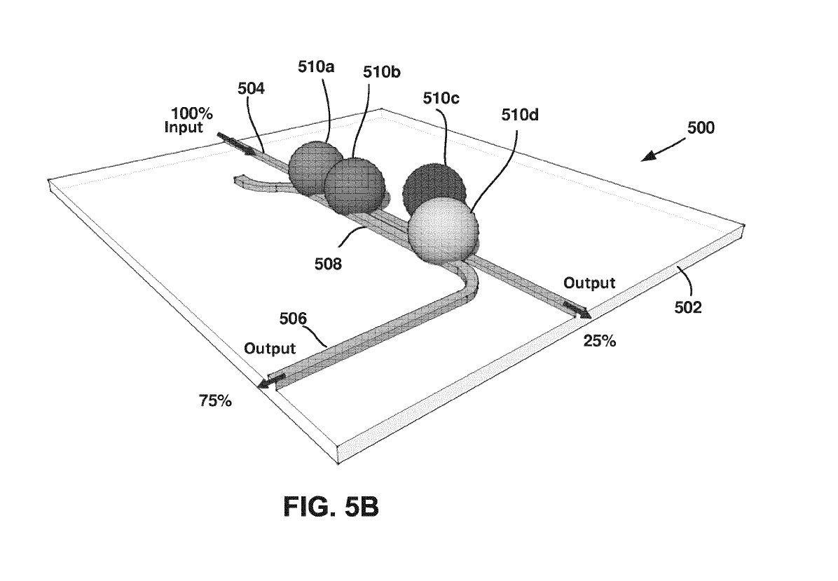

One embodiment of a multiple state, microfluidic optical switch is schematically illustrated in FIGS. 5A-B. Such a switch is capable of switching among more than two, i.e. it has a minimum coupling state, a maximum coupling and one or more intermediate coupling states. FIG. 5A schematically shows a microfluidic switch 500 formed on a substrate 502 having a first waveguide 504 and a second waveguide 506. A coupling region 508 is a region where the first and second waveguides 504, 506 are spaced closely together to permit optical coupling between the waveguides 504, 506. In the illustrated embodiment, light propagates along the first waveguide in the direction shown by the arrows, entering the switch at the input and exiting the switch at the outputs. According to the coordinate system of the figure, the light propagates along the y-direction. In this embodiment, the switch 500 includes four activatable microfluidic droplets 510, labelled 510a, 510b, 510c and 510d, near the coupling region 508. The four droplets 510 are independently movable in the ±x direction. When a droplet 510 is moved in a position above the waveguides 504 and 506, the coupling coefficient is changed so that a fraction of the light propagating in the first waveguide 504 is coupled into the second waveguide 506. In this embodiment the droplets 510 can have one of two positions, namely i) away from the coupling portion, for example as shown for droplets 510c and 510d, in a position that does not contribute to the coupling coefficient, and ii) over the coupling portion, as is shown for droplets 510a and 510b, in a position that does contribute to the coupling coefficient. Thus, in the droplet configuration illustrated in FIG. 5A, only droplets 510a and 510b affect coupling of light from the first waveguide 504 to the second waveguide 506.

The amount by which a droplet 510 affects the coupling coefficient can depend on a number of different factors including the size of the droplet and the magnitude of the change in the effective refractive index experienced by light in the waveguide. When the droplet is larger, for example when it extends further along the waveguide in the y-direction, the coupling coefficient is increased. The change in the effective refractive index of the waveguide is dependent on the refractive index of the droplet 510. Generally, when the difference between the refractive indices of the droplet 510 and the waveguides is smaller, the coupling coefficient increases.

In one example of the embodiment illustrated in FIG. 5A, each droplet 510 has the same effect on coupling coefficient, and increases the coupling coefficient by 25%. Thus, for each droplet 510 positioned in the coupling region 508 to couple light between the waveguides 504, 506, the amount of light coupled from the first waveguide 504 to the second waveguide 506 is increased by 25%. In the illustrated embodiment two droplets 510a, 510b are positioned in the coupling region 508 to couple light between the waveguides 504, 506, so 50% of the light is coupled from the first waveguide 504 to the second waveguide 506. In another droplet configuration, schematically illustrated in FIG. 5B, three droplets 510a, 510b and 510d are positioned in the coupling region 508 the coupling region to couple light between the waveguides 504, 506. In this case, 75% of the light is coupled from the first waveguide 504 into the second waveguide 506, with 25% of the light propagating in the first waveguide 504 beyond the coupling region.

While the waveguides 504, 506 are shown in FIGS. 5A-B are shown sitting on top of the substrate 502, it is not intended that this be a limitation of the invention herein. The waveguides of this and other embodiments may be formed in any conventional manner, including growing the waveguides on a substrate or in the substrate via diffusion or implantation or other suitable technique. Thus, waveguides may be formed on and/or in a substrate.

An advantage of optical microfluidic switched optical circuits discussed herein is that a control signal need only be applied to change a switch state, to move the droplet from one position to another but need not be continually applied to maintain the switch in that state. The microfluidic switches can persist in a selected state after being switched to that state without continued application of the control signal, since an activation signal is only required to move a droplet from one position to another. Once a droplet has reached a desired position, it remains in that position until another activation signal is applied to remove it. Microfluidic droplets can typically be moved using electrostatic or hydrostatic forces.

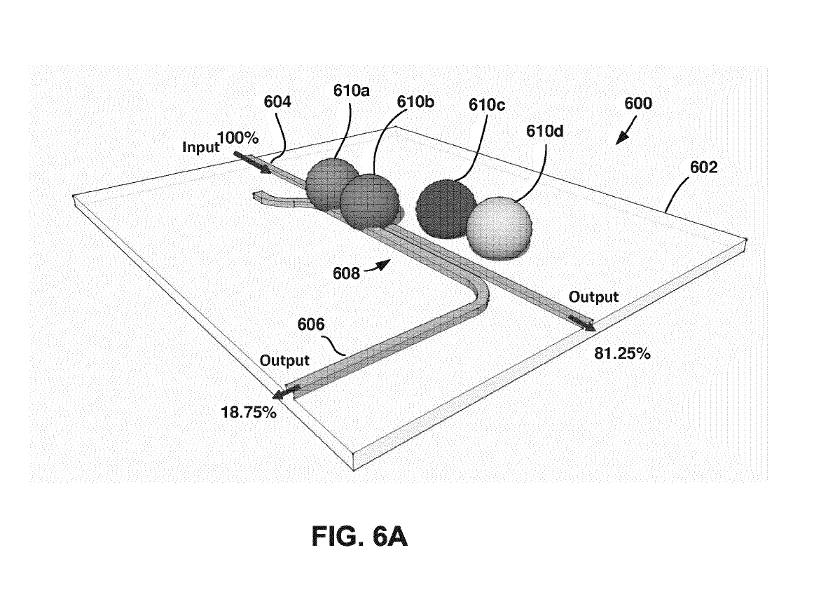

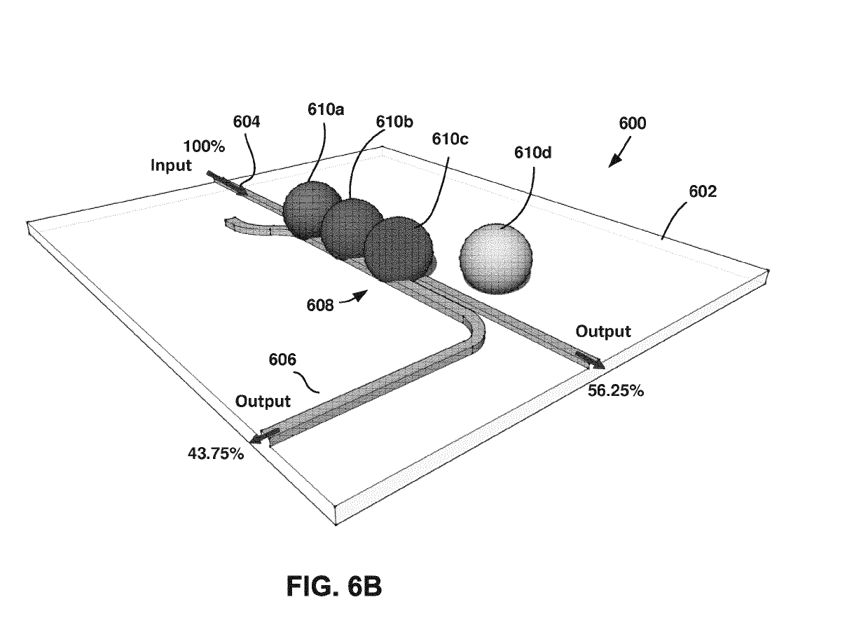

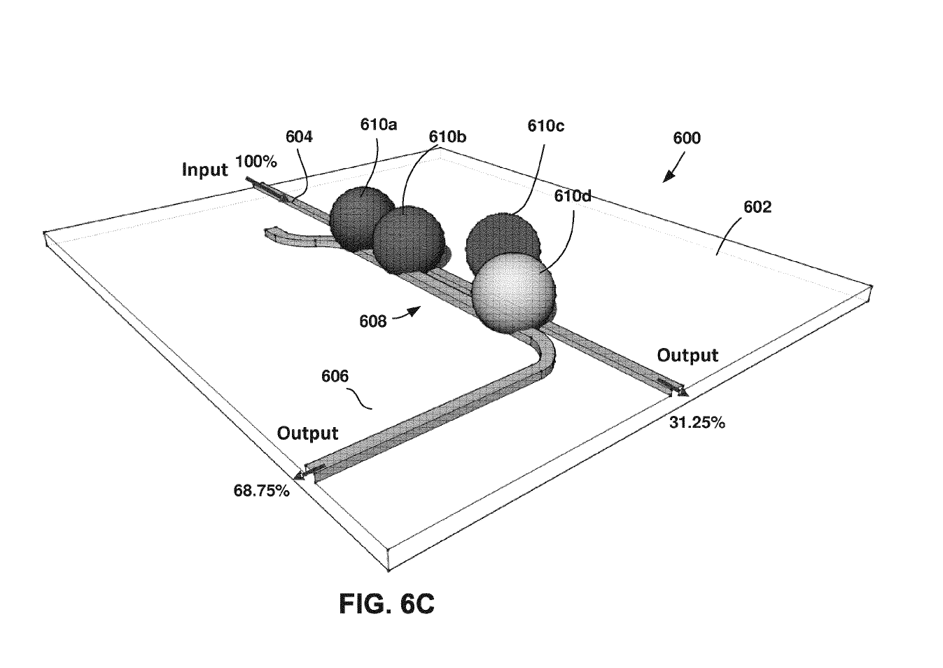

It will be understood that the droplets need not all contribute the same amount of coupling, and different droplets may contribute respectively different amounts of coupling. The amount of coupling contributed by each droplet may be selected so that the user can select a number of different coupling values. For example, a first droplet may provide 6.25% coupling between the waveguides, while a second droplet provides 12.5% coupling, a third droplet provides 25% coupling and a fourth droplet provides 50% coupling. Various arrangements of these four droplets will provide up to 16 different values of coupling. To illustrate, in another exemplary embodiment, schematically shown in FIG. 6A, a first waveguide 604 is located on a substrate 602 of a microfluidic optical switch 600, along with a second waveguide 606. A coupling region 608 is provided where optical coupling between the waveguides 604, 606 may take place. The first droplet 610a provides 6.25% coupling between the two waveguides 604, 606, the second droplet 610b provides 12.5% coupling between the two waveguides 604, 606, the third droplet 610c provides 25% coupling between the two waveguides 604, 606 and the fourth droplet 610d provides 50% coupling between the two waveguides. Thus, in the droplet configuration illustrated in FIG. 6A, droplets 610a and 610b are in position to optically couple light between the waveguides 604 and 606, and so 18.75% (12.5%+6.25%) of the light is coupled from the first waveguide 604 to the second waveguide 606, and 81.25% is left to propagate along the first waveguide 604. In the droplet configuration illustrated in FIG. 6B, the first, second and third droplets 610a, 610b and 610c are in position to couple light between the waveguides 604, 606. In this case, 43.75% (6.25%+12.5%+25%) of the light is coupled into the second waveguide 606 from the first waveguide 604, with 56.25% of the light remaining in the first waveguide 604. In another droplet configuration illustrated in FIG. 6C, the first, second and fourth droplets 610a, 610b and 610d are in position to couple light between the waveguides 604, 606. In this case, 68.75% (6.25%+12.5%+50%) of the light is coupled into the second waveguide 606 from the first waveguide 604. It will be appreciated that other configurations will result in different amounts of light being coupled from the first waveguide 604 to the second waveguide 606. It will further be appreciated that different numbers of droplets may be incorporated in a multi-state switch and that amount of coupling attributable to each droplet may be selected to have different values from those discussed in the example above.

The description of optical switches herein ignores optical losses due to, for example, impurities, fabrication errors and the like. Accordingly, values of light transmission, coupling etc. given as a percentage or fraction should be understood to cover an ideal embodiment, while actual devices may not operate with the same values are exemplified herein. In illustration, the droplets in a real device of the above embodiment may not produce the exact same values of coupling as described, which are provided for illustration purposes only, but may operate within an approximate range of these values.

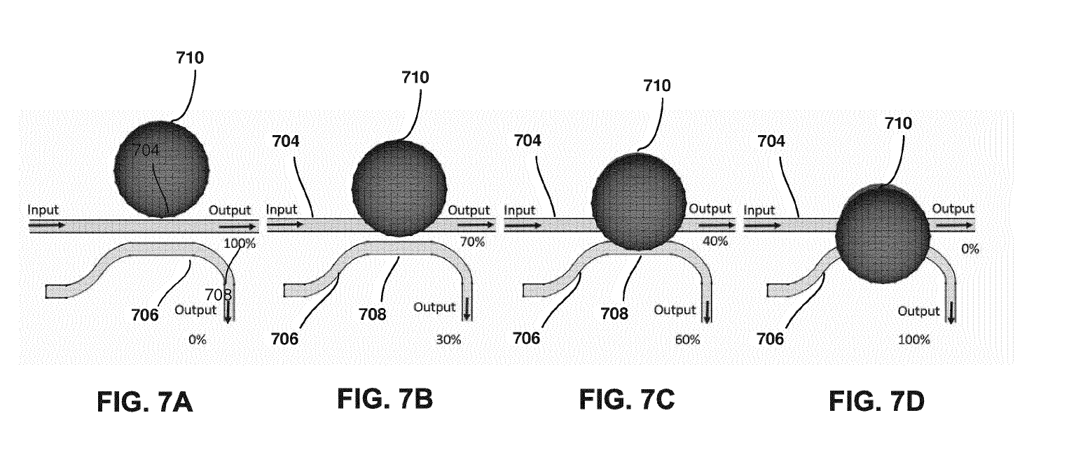

In another approach to a multi-state optical switch, a microfluidic droplet may be controllably moved to one of several different positions relative to the coupling region between two waveguides, resulting in respectively different levels of coupling when the droplet is in the different positions. One embodiment of such an optical switch is schematically illustrated in FIGS.7A-7D. The switch includes a first waveguide 704 and a second waveguide 706. Portions of the first and second waveguides 704, 706 are positioned closely together to form a coupling portion 708 where light is coupled between the waveguides 704,706. In this embodiment, the droplet 710 is moved in a transverse direction across the waveguides 704, 706. In FIG. 7A the droplet 710 is in a first position removed from the coupling portion 708 so that no coupling takes place between the waveguides 704, 706. In FIG. 7B the droplet 710 is in a second position closer to the coupling portion 708 than the first position to couple a first amount of light from the first waveguide 704 to the second waveguide 706. In the illustration, 30% of the light in the first waveguide 704 is coupled to the second waveguide 706 when the droplet 710 is in the second position. In FIG. 7C the droplet 710 is in a third position closer to the coupling portion 708 than the second position to couple a second amount of light from the first waveguide 704 to the second waveguide 706, that is larger than the first amount of light. In the illustration, 60% of the light in the first waveguide 704 is coupled to the second waveguide 706 when the droplet 710 is in the third position, leaving 40% of the light in the first waveguide 704. In FIG. 7D the droplet 710 is in a fourth position closer to the coupling portion 708 than the third position to couple a third amount of light from the first waveguide 704 to the second waveguide 706. In the illustration, 100% of the light in the first waveguide 704 is coupled to the second waveguide 706 when the droplet 710 is in the fourth position, leaving no light in the first waveguide 704.

In a variation of the embodiment shown in FIGS. 7A-7D, the droplet 710 may have a refractive index that is non-uniform over the range of light wavelengths that pass along the waveguides. For example, the refractive index of the fluid may be tailored using an additive such as semiconductor quantum dots or the like. Thus, the switch may be able to demonstrate a wavelength-dependent switching ability, and be able to couple light at a first wavelength relatively strongly while coupling light at a second wavelength either relatively weakly, if not at a zero level. Such a switch is referred to as a wavelength-dependent microfluidic switch. It will be appreciated that such wavelength dependence may be included into the other embodiments of microfluidic switch, and optical circuits including such switches, described herein.

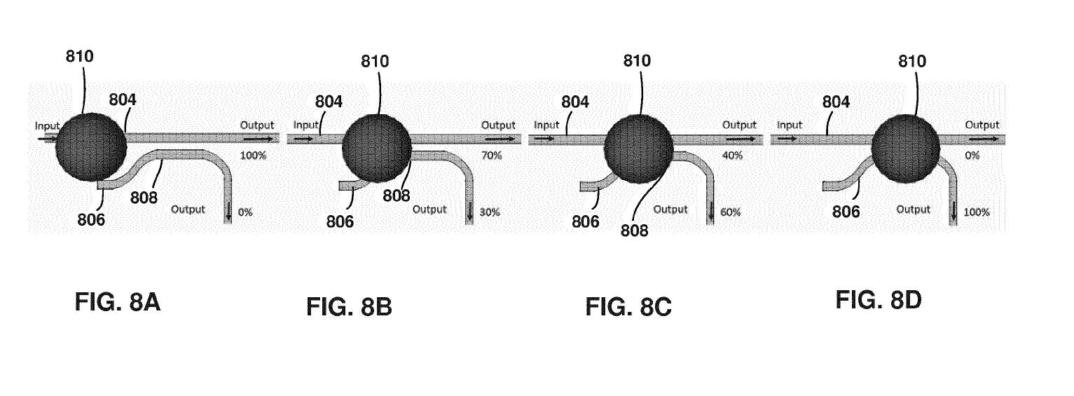

Another embodiment of an optical switch having a multiple switching states is schematically illustrated in FIGS. 8A-8D. The switch includes a first waveguide 804 and a second waveguide 806. Portions of the first and second waveguides 804, 806 are positioned closely together to form a coupling portion 808 where light is coupled between the waveguides 804, 806. In this embodiment, the droplet 810 is moved in a longitudinal direction approximately across the waveguides 804, 806. In FIG. 8A the droplet 810 is in a first position removed from the coupling portion 808 so that no coupling takes place between the waveguides 804, 806. In FIG. 8B the droplet 810 is in a second position closer to the coupling portion 808 than the first position to couple a first amount of light from the first waveguide 804 to the second waveguide 806. In the illustration, 30% of the light in the first waveguide 804 is coupled to the second waveguide 806 when the droplet 810 is in the second position. In FIG. 8C the droplet 810 is in a third position closer to the coupling portion 808 than the second position to couple a second amount of light from the first waveguide 804 to the second waveguide 806. In the illustration, 60% of the light in the first waveguide 804 is coupled to the second waveguide 806 when the droplet 810 is in the third position, leaving 40% of the light in the first waveguide 804. In FIG. 8D the droplet 810 is in a fourth position closer to the coupling portion 808 than the third position to couple a third amount of light from the first waveguide 804 to the second waveguide 806. In the illustration, 100% of the light in the first waveguide 804 is coupled to the second waveguide 806 when the droplet 810 is in the fourth position, leaving no light in the first waveguide 804.

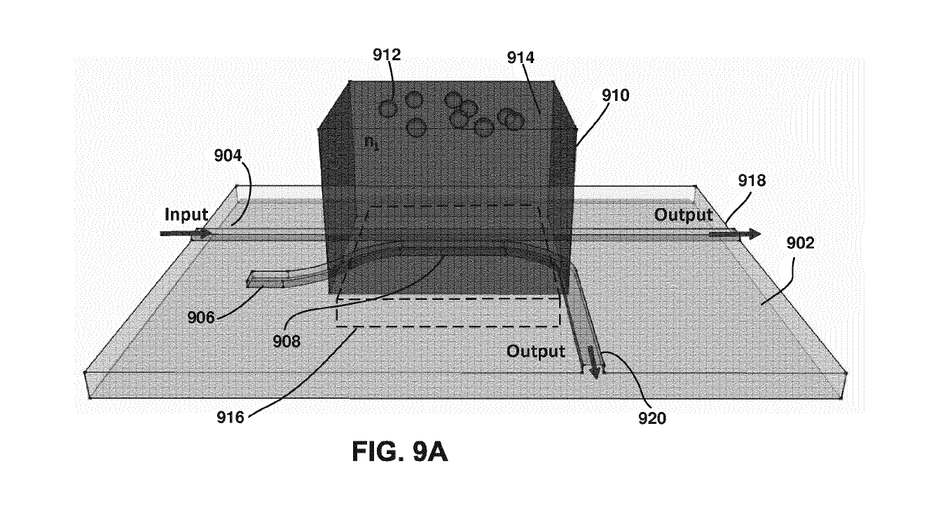

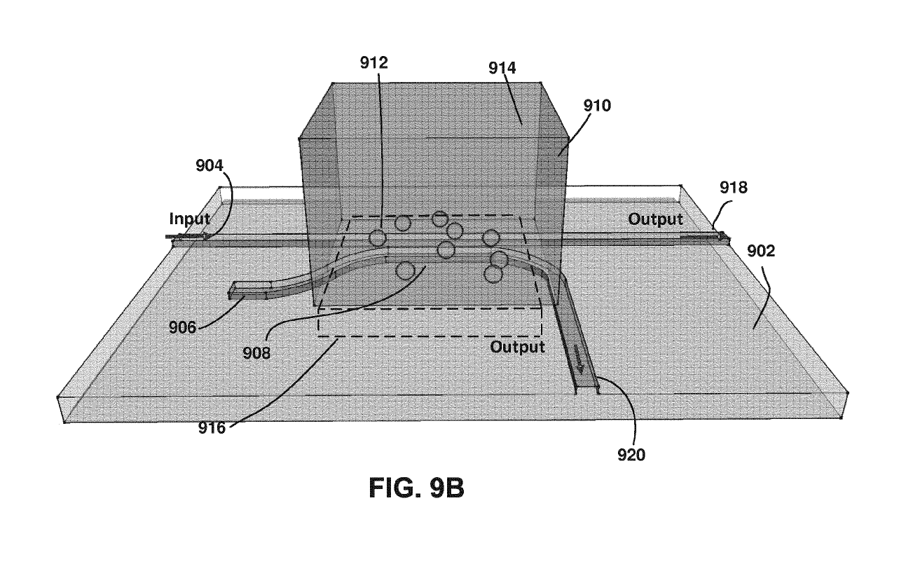

Another approach to changing the effective refractive index experienced by light passing through an optical switch is now discussed with regard to the embodiment schematically illustrated in FIGS. 9A and 9B. In this embodiment, a substrate supports a first waveguide 904 and a second waveguide 906. The two waveguides 904, 906 are located closely to one another to form a coupling region 908 where optical coupling can take place between the waveguides 904, 906, depending on the effective refractive index experienced by light propagating along the waveguides 904, 906.

A capsule 910 above the coupling region 908 contains particles 912 in a fluid 914. The particles 912 have a different refractive index from the fluid 914 and are moveable within the fluid under the application of an external force. For example, the particles 912 may be magnetic and, therefore, moveable under the application of a magnetic field. Magnetic particles 912 may include a magnetic core that is coated with another material or may include a magnetic component that is attached to another component, for example a relatively small magnetic component may be attached to a relatively large nonmagnetic component that has a refractive index different from the refractive index of the fluid.

An external magnetic field applied to the capsule 910 can result in the particles 912 moving within the fluid 914. The magnetic field source 916 may be placed under the substrate 902, as illustrated, or may be placed above the substrate 902 if it is desired to move the particles in a direction perpendicular to the substrate 902. In FIG. 9A the particles 912 are located towards the top of the capsule 910, so that they have little effect on the effective refractive index in the coupling region 908. This may be termed a first coupling state. In FIG. 9B the particles are located towards the bottom of the capsule 910, so as to affect the effective refractive index of the coupling region. This may be termed a second coupling state. In some embodiments the refractive indices of the fluid 914 and particles 912 may be selected so that the first coupling state is a bar state, in other words, light propagating along the first waveguide 904 is not coupled to the second waveguide 906, and appears at the first waveguide output 918. In these embodiments, the second coupling state may be a cross state, in which light propagating along the first waveguide 904 is coupled to the second waveguide 906. Depending on the degree of coupling at the coupling region 908, all the light may be coupled to the second waveguide 906 or a certain fraction of the light may be coupled from the first waveguide 904 to the second waveguide 906. In other embodiments, the refractive indices of the fluid 914 and particles 912 may be selected so that the first coupling state is a cross state, in other words, light propagating along the first waveguide 904 is coupled to the second waveguide 906. Depending on the degree of coupling at the coupling region 908, all the light may be coupled to the second waveguide 906 or a certain fraction of the light may be coupled from the first waveguide 904 to the second waveguide 906, with the remainder appearing at the first waveguide output 918. In these embodiments, the second coupling state may be a bar state, in which light propagating along the first waveguide 904 is not coupled to the second waveguide 906 and appears at the first waveguide output 918.

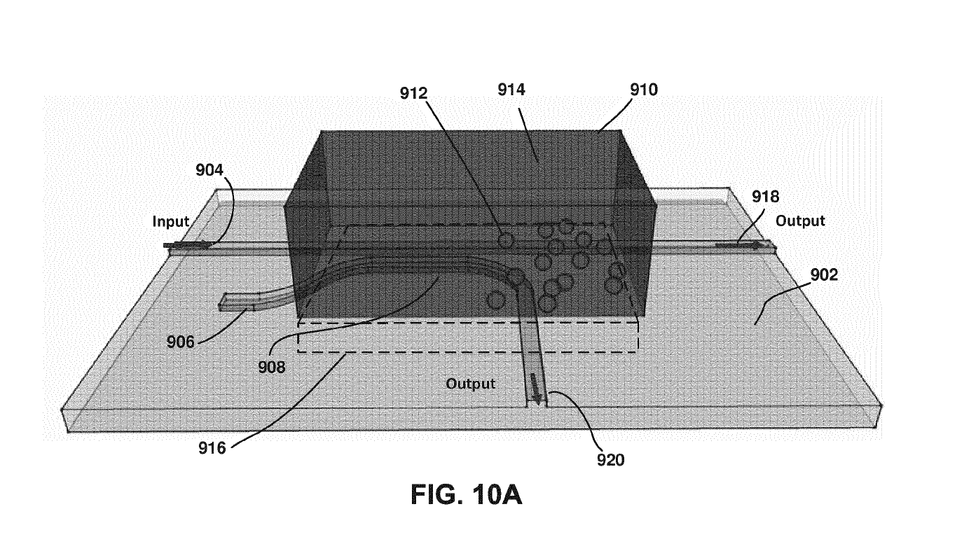

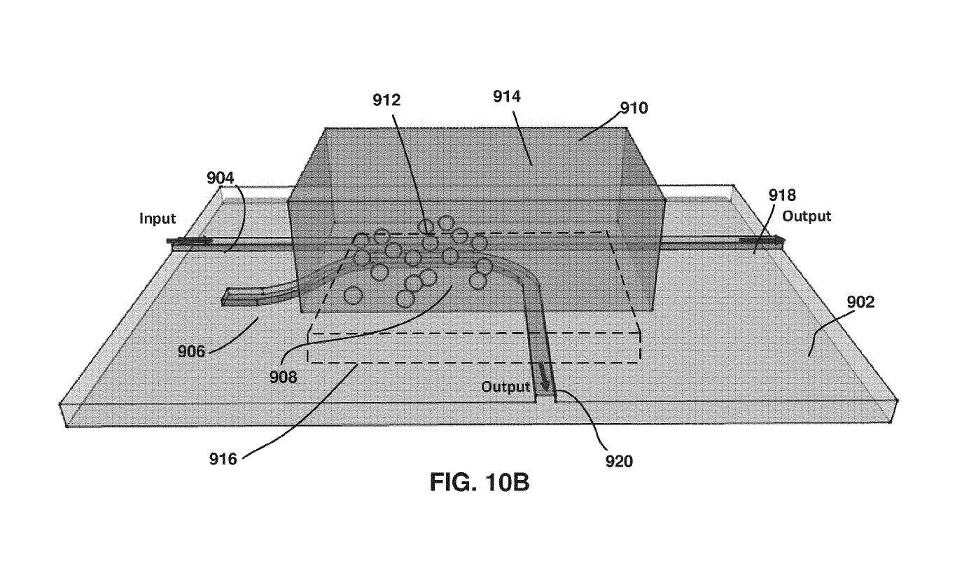

It will be appreciated that the particles 912 need not be restricted to moving only in a vertical direction, perpendicular to the substrate 902, to change the amount of optical coupling between the first and second waveguides 904, 906 at the coupling region 908. In other embodiments, the particles 912 may be moved transverse across the waveguides 904, 906 or along the waveguides 904, 906 to affect the amount of optical coupling at the coupling region 908. The latter case, where the particles 912 are moved along the waveguides 904, 906, is illustrated in FIGS. 10a and 10B. In FIG. 10A the particles 912 are located in a position removed from the coupling region and so have little effect on the effective refractive index experienced at the coupling region 908. In FIG. 10B, the particles 912 are located above the coupling region 908 and do affect the effective refractive index at the coupling region.

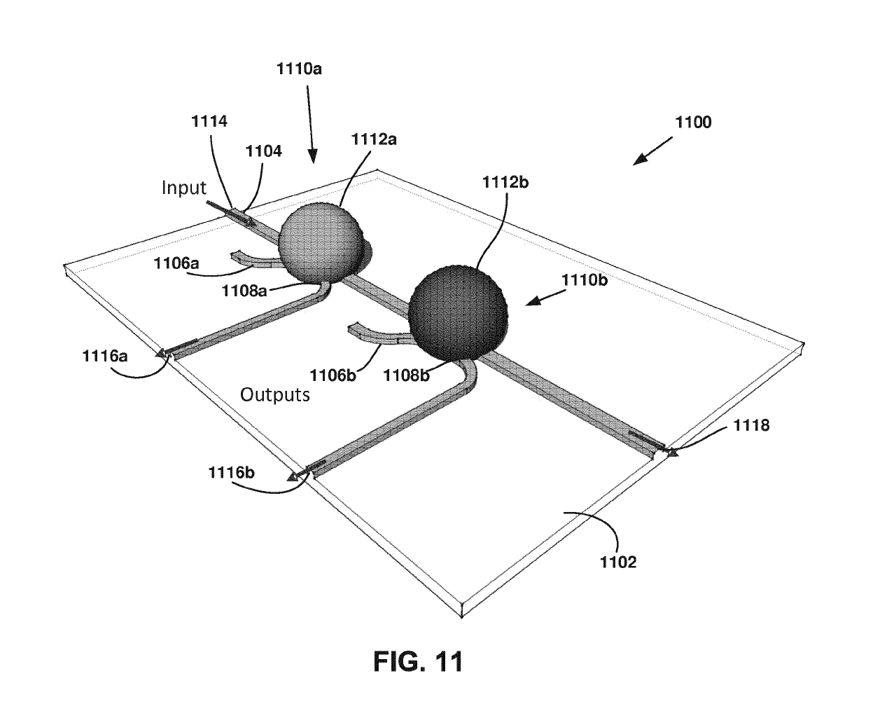

An embodiment of an optical circuit 1100 that includes more than one optical switch placed along a waveguide is schematically illustrated in FIG. 11. The circuit 1100 has a substrate 1102 which supports a first waveguide 1104. A first switch 1110a is formed at a first coupling region 1108a between the first waveguide 1104 and a second waveguide 1106a. A second switch 1110b is formed at a second coupling region 1108b between the first waveguide 1104 and a third waveguide 1106b. In the illustrated embodiment, the first and second switches 1110a, 1110b are shown with a fluid droplet 1112a, 1112b over the respective coupling regions 1108a, 1108b. It will be appreciated that any of the different types of optical switch discussed above may be used as the switches 1110a, 1110b, including embodiments of optical switch that permit various levels of optical coupling between two waveguides.

In operation, the optical circuit 1100 may be used to generate three output different signals having selected power levels. In illustration, consider that an optical signal is input to the first waveguide 1104 at the input 1114. If the first switch 1110a is set to couple a fraction X (between 0 and 1) of the input light, I₀, into the second waveguide 1106a, then the amount of light passing to the second switch 1110b is (1−X) I₀, while XI₀ passes out of the second waveguide output 1116a. If the second switch 1110b is set to couple a fraction Y(between 0 and 1) of the passing light into the third waveguide 1106b, then Y(1−X) I₀ is coupled out of the third waveguide output 1116b, and (1−X)(1−Y)I₀ passes to the output 1118 of the first waveguide 1104. It will be appreciated that, according to some of the switch embodiments discussed above, different values of X and Y may be selected so that desired relative amounts of light are obtained at the outputs.

Additionally, it will be appreciated that additional switches may be used in the circuit 1100, for example switches may be added on the second or third waveguides 1106a, 1106b to couple light into additional waveguides, or may be positioned on the first waveguide 1004 downstream of the second switch 1110b.

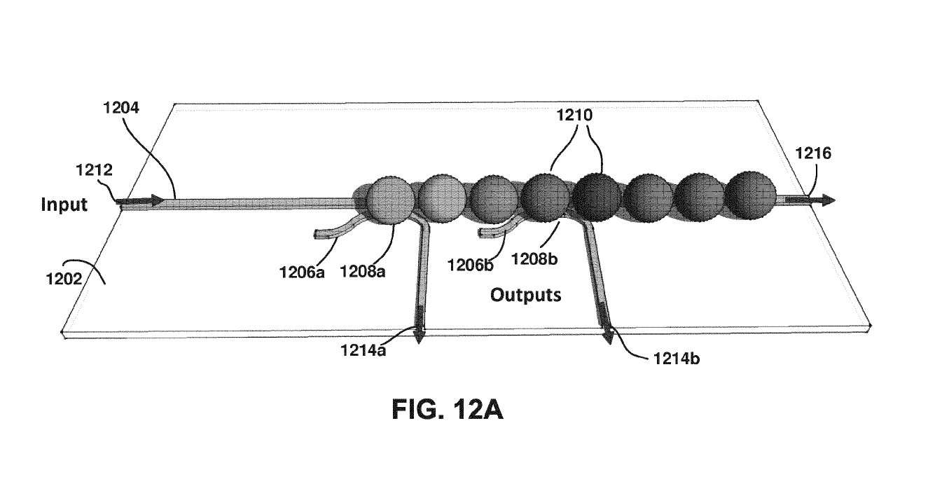

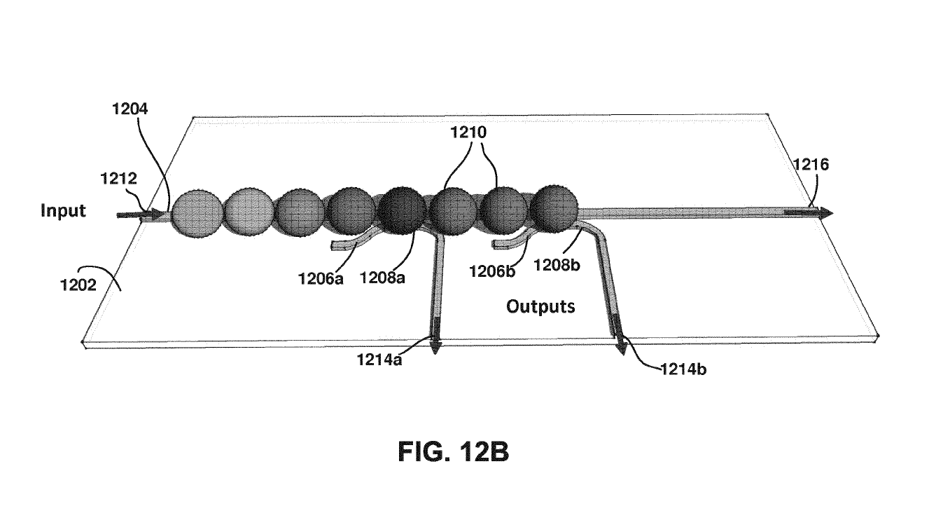

Another embodiment of an optical circuit arrangement that arrangement that permits the switching of light from a single to multiple waveguides is schematically illustrated in FIGS. 12A and 12B. This embodiment shows an approach to switching light out of one waveguide into two waveguides, but this approach can be extended to cover switching into more than two waveguides. A substrate 1202 supports a first waveguide 1204. Second and third waveguides 1206a, 1206b are positioned so as to form coupling regions 1208a, 1208b with the first waveguide 1204. In this embodiment, a number of droplets 1210 are positionable over the coupling regions 1208a, 1208b. The positions of the droplets 1210 relative to the coupling regions 1208a, 1208b can affect the effective refractive index at the coupling regions 1208a, 1208b, resulting in coupling light from the first waveguide 1204 to the second and third waveguides 1206a, 1206b. The droplets 1210 may be moved in position, for example as shown in FIGS. 12A and 12B, in a manner that changes the amount of optical coupling at the coupling regions 1208a, 1208b. In some embodiments, the refractive index of one or more droplets 1210 may be different from the refractive indices of other droplets, which may result in a greater change in the amount of optical coupling when the position of the droplets 1210 is changed. Thus, in the configuration shown in FIG. 12A, if an amount of light I₀ enters the first waveguide input 1212, and the light exiting the second waveguide output 1214a is XL while the light exiting the third waveguide output 1214b is YI₀, then the amount of light leaving the first waveguide output 1216 is (1−X−Y)I₀, where (X+Y)≦1. In the configuration shown in FIG. 12B, the amount of light exiting the second and third waveguide outputs 1214a, 1214b is X′I₀ and Y′I₀ and the amount of light exiting the first waveguide output 1216 is (1−X′−Y′)I₀, where (X′+Y′)≦1 and X≠X′ and Y≠Y′. The values of X, Y and X′, Y′ are selectable by changing the position of the droplets 1210.

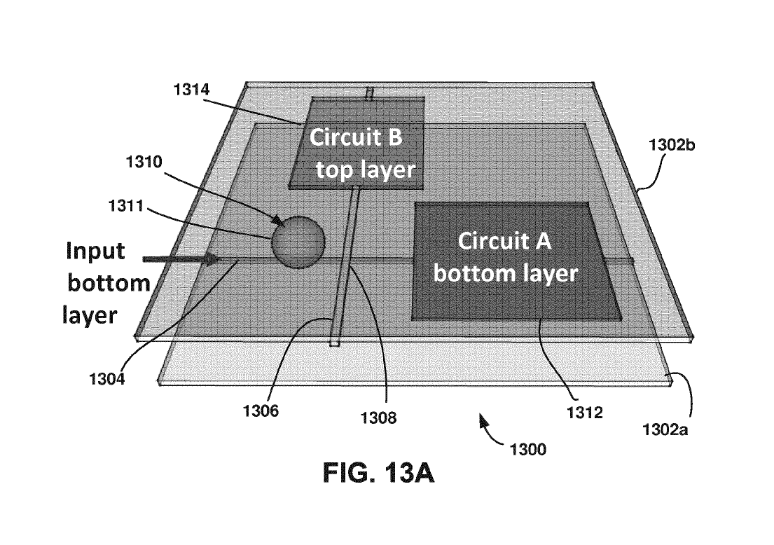

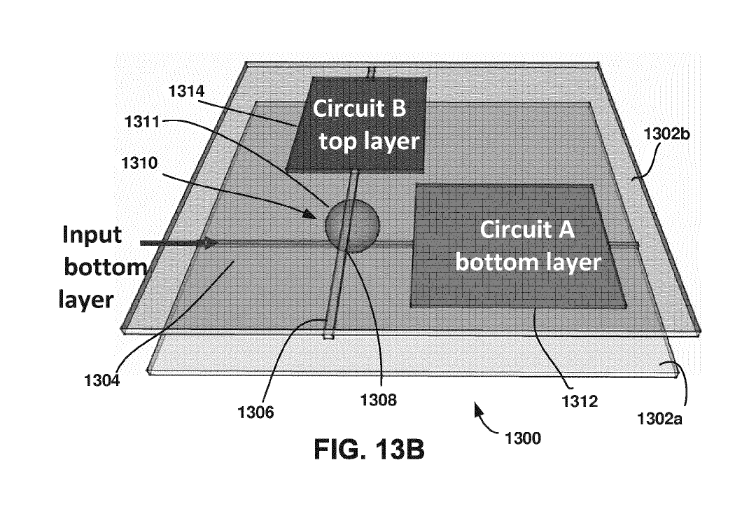

In the embodiments discussed so far, light is switched between waveguides present on the same substrate. In other embodiments, light may be switched from a first waveguide on a first substrate to a second waveguide on a second substrate. An optical circuit that uses more than one substrate may be useful in reducing the footprint required to achieve certain optical functions. For example, as is schematically illustrated in FIGS. 13A and 13B, an optical circuit 1300 may include first and second substrates 1302a, 1302b, with the first substrate 1302a containing circuit A 1312 and the second substrate 1302b containing circuit B 1314. The first substrate 1302a supports a first waveguide 1304 connected to circuit A 1312 and the second substrate 1302b supports a second waveguide 1306 connected to circuit B 1314. A coupling region 1308 is formed between the first and second waveguides 1304, 1306 and an optical switch 1310 formed at the coupling region 1308 allows light to be coupled between the first and second waveguides 1304, 1306. The optical switch 1310 may include any suitable embodiment of optical switch discussed hereon. In the illustrated embodiment, a single fluid droplet 1311 is used for switching.

Although the figures show that the first waveguide 1304 crosses the second waveguide 1306, this is not a necessary requirement, and is shown only for clarity. It will be appreciated that the coupling region 1308 may be formed between regions of the waveguides 1304, 1306 that are substantially parallel, in a manner similar to certain of the embodiments discussed earlier. Any suitable arrangement of the waveguides 1304, 1306 may be used to form the coupling region 1308. However, in this embodiment, when light is coupled between the first waveguide 1304 and the second waveguide 1306 the light passes from a waveguide on one substrate to a waveguide on another substrate.

If light is input to the circuit 1300 via the first waveguide 1304, then light can pass to circuit A 1312 if the optical switch 1310 is in the bar state, as illustrated in FIG. 13A, or to circuit B 1314 if the optical switch 1310 is in the cross state. It will be appreciated that the switch 1310 may permit light to pass to both circuits A and B 1312, 1314 if the switch 1310 couples a fraction of the incoming light to the second waveguide 1306 while at the same time permitting some of the light to pass along the first waveguide 1304.

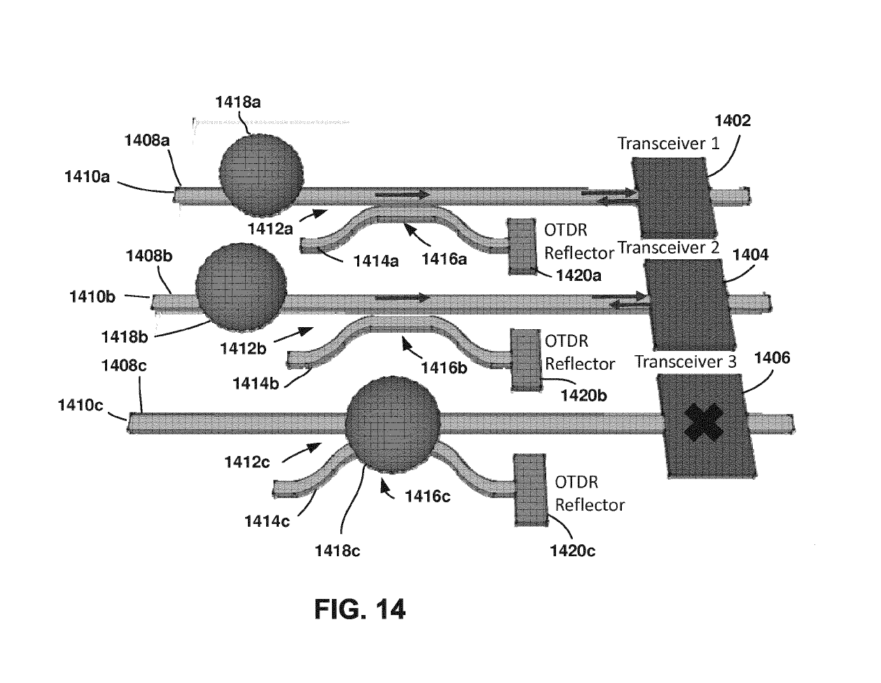

The switches and optical circuits discussed above may be used in the FDH. In other applications, switches may be used elsewhere, such as at the end user's location. For example, an end user's location may be supplied with not only a transceiver for receiving and sending optical signals, it may also be provided with an optical time domain reflectometry (OTDR) facility that permits the operator to test the optical fiber all the way up to the individual end user. One example of an implementation of this is schematically illustrated in FIG. 14, which shows three different transceivers 1402, 1404 and 1406 coupled to respective waveguides 1408a, 1408b, 1408c. Each transceiver 1402, 1404, 1406 may be at a different end user's location. The input end 1410a, 1410b, 1410c of each waveguide 1408a-c may be coupled to separate optical fibers from an FDH. Each waveguide 1408a-c is provided with a respective optical switch 1412a, 1514b, 1412c that includes a second waveguide 1414a, 1414b, 1414c that form coupling regions 1416a, 1416b, 1416c where light can be coupled between the waveguides 1408a-c and respective second waveguides 1414a-c. The switches 1412a-c may be activated in a manner as discussed above, for example using one or more microfluidic droplets. In the illustrated embodiment the switches 1412 are activated by a microfluidic droplet 1418a, 1418b, 1418c. The second waveguides 1414a-c are provided with OTDR reflectors 1420a, 1420b, 1420c that reflect light at the wavelength received from the FDH or Central Office, for example distributed Bragg reflectors (DBRs) or the like.

When the switches 1410a-c are in the bar state, no incoming light is coupled to the OTDR reflector, and the light is detected by the transceivers 1402, 1404, 1406. If a switch is set to the cross state, light is coupled to the OTDR reflector associated with that switch and a large portion of the incoming light is reflected back to the FDH or Central Office. Also, the amount of light reaching the transceiver is reduced, perhaps almost to zero if the coupling is very high in the optical switch. Such a situation is schematically illustrated in FIG. 14. The switches 1412a, 1412b associated with the first and second transceivers 1402, 1404 respectively are in the bar state, since the droplets 1418a, 1418b are removed from the coupling regions 1416a, 1416b. The third switch 1412c, associated with the third transceiver 1406, however, is in the cross state, and so light input at 1410c is efficiently reflected by the OTDR reflector 1420c. At the same time, little or no optical signal reaches the third transceiver 1406. Such an arrangement permits the operator to remotely test the optical transmission path from the Central office all the way to the end user's facility. It also permits the operator to turn off a dysfunctional transceiver at the user's end.

In another embodiment, one or more optical switches may be located on optical paths leading out of an FDH. For those optical paths whose switches are in the bar state, the optical signals are transmitted out of the FDH to the respective end users. However, a switch in the cross-state may be used to direct an optical signal out of the network, e.g. into an optical dump, so as to prevent the output of that optical signal. This may be useful for the operator, for example, in controlling which end users receive signals and which do not, or for preventing the transmission of an optical signal along a fiber that is in place but is not yet connected to an end user.

The reflection spectrum of the OTDR reflectors 1420a-c may be selected to be specific to the laser spectrum used for the OTDR measurement, or may be broader band to reflect light over a large range of wavelengths. In addition, the reflection spectrum may be tailored to be effective over a range of operating temperatures, both the operating temperature of the OTDR reflector and the laser used for the OTDR measurement.

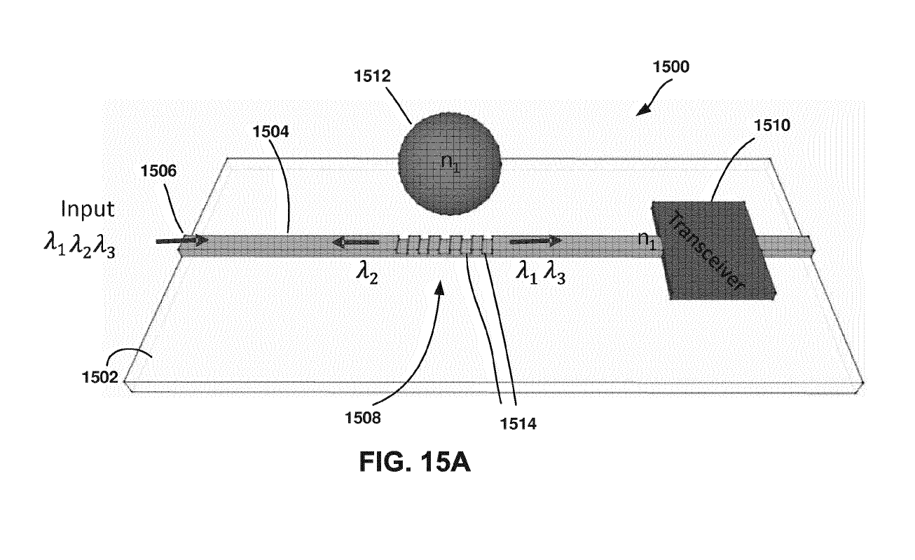

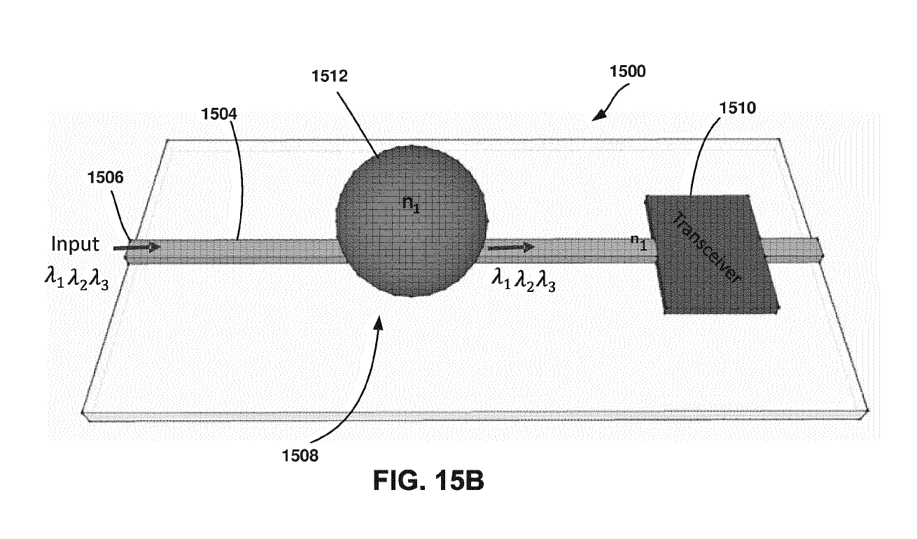

An embodiment of a wavelength dependent optical switch 1500 is schematically illustrated in FIGS. 15A and 15B. A substrate 1502 supports an optical waveguide 1504 into which light is supplied at an input 1506. The waveguide 1504 includes a grating reflector 1508, for example a DBR, that is particularly reflective at a select wavelength, for example λ₂. Thus, if light at three different wavelengths, λ₁, λ₂, λ₃, is input to the waveguide 1504, the light at λ₂ will be reflected while the light at λ₁ and λ₃ will be transmitted. The transmitted light at λ₁ and λ₃ may be detected, for example, by a transceiver 1510.

The wavelength dependent optical switch 1500 includes one or more microfluidic droplets 1512. The illustrated embodiment shows only a single droplet 1512 for simplicity. In FIG. 15A the droplet 1512 is positioned away from the reflector 1508 so as to have a reduced, or minimal, effect on the reflector 1508. In FIG. 15B the droplet 1512 is positioned close to the reflector 1508. With appropriate selection of the refractive index and the extent of the droplet 1512, the effective refractive index of the reflector 1508 can be changed so as to reduce the reflectivity at λ₂, thus permitting the light at λ₂ to be transmitted and reach the transceiver 1510. In some embodiments, the microfluidic droplet 1512 has the same refractive index as the waveguide 1504. When the droplet 1512 is moved into a position over the reflector 1508, the refractive index of the fluid affects the refractive indices of the grating reflector 1508. In some embodiments, the grating reflector 1508 is formed with recesses 1514 which may be filled by the fluid. Where the refractive indices of the fluid droplet 1512 and waveguide 1504 are the same, the grating is effectively erased when the droplet 1512 is over the grating reflector 1508, permitting light at λ₂ to be transmitted.

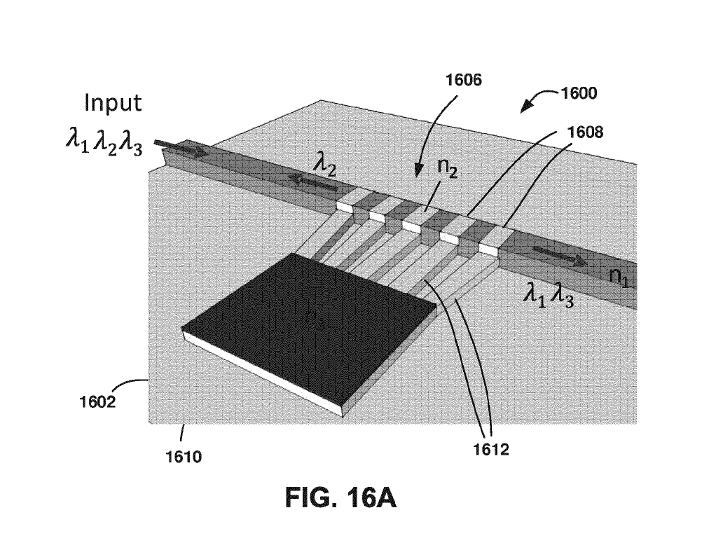

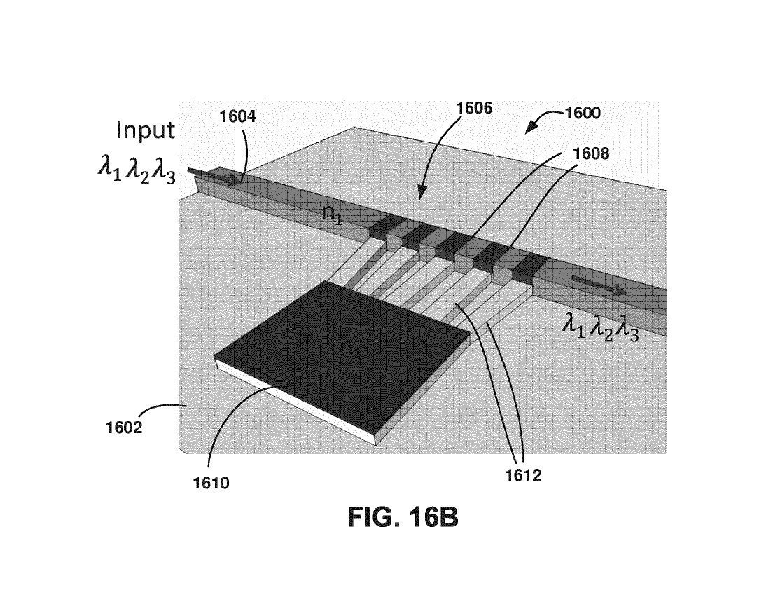

Another embodiment of a wavelength dependent optical switch 1600 is schematically illustrated in FIGS. 16A and 16B. A substrate 1602 supports a waveguide 1604 that has a grating reflector 1606. The grating reflector 1606 may be formed as a grating in the waveguide 1604. For example, the waveguide 1604 may be formed from a material having a refractive index of n₁. The grating is formed from repeated regions 1608 in the waveguide 1604 having a different refractive index, n₂. The reflection spectrum of the grating reflector 1606 depends on a number of factors, including the relative spacing between the repeated regions 1608 having the different refractive index. As in the example discussed above, the reflection spectrum of the grating reflector 1606 may be selected for operation under a number of different conditions.

In the illustrated embodiment, the grating reflector 1606 normally reflects light at a wavelength λ₂ and transmits light at other wavelengths, for example λ₁ and λ₃. Reflection by the grating reflector can be controlled by shape-controlled microfluidics. A reservoir 1610 contains a fluid having a refractive index different from n₂, for example n₃. One or more ducts 1612 lead from the reservoir 1610 to the repeated regions 1608, permitting the refractive index of the repeated regions 1608 to be changed from n₂, when the fluid is absent from the repeated regions 1608, to n₃ when the fluid is present in the repeated regions 1608. When the refractive index of the repeated regions 1608 is changed from n₂ to n₃, for example by moving the liquid into the repeating regions 1608, the reflection properties of the reflecting grating can be changed. For example, where the liquid has a refractive index, n₃, that is approximately equal to that of the waveguide material, n₁, the reflectivity of the grating reflector 1606 can be reduced to close to zero, effectively allowing light at λ₂ to be transmitted through the grating reflector 1606, as is schematically illustrated in FIG. 16B.

One example where such an optical switch 1600 may be used is in a situation like that shown in FIGS. 15A-15B, where the wavelength dependent optical switch is used to isolate light at a selected wavelength from a transceiver while permitting other wavelengths to be transmitted to the transceiver. This might be useful, for example, if light at λ₂ is used for OTDR measurements. Under normal circumstances it may be preferred to permit all wavelengths to reach the transceiver, but to have a reflector at λ₂ active just in front of the transceiver when OTDR measurements are to be made.

While various examples were provided above, the present invention is not limited to the specifics of the examples. For example, various combinations of elements shown in different figures may be combined together in various ways to form additional optical circuits not specifically described herein.

As noted above, the present invention is applicable to fiber optical communication and data transmission systems. Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An optical device, comprising:
a waveguide splitter cascade comprising at least first and second tiers of waveguide splitter nodes, each waveguide splitter node comprising a respective input waveguide coupled to two respective output waveguides;
wherein at least one output waveguide of the first tier of waveguide splitters comprises an input waveguide of a waveguide splitter of the second tier of waveguide splitters; and
an active optical switch having two or more inputs and an output connected as an input to one of the waveguide splitter nodes.

2. The device recited in claim 1, wherein one of the two or more inputs to the active optical switch comprises an output from an upstream waveguide splitter.

3. The device as recited in claim 1, wherein at least one of the splitter nodes is a symmetric splitter node.

4. The device as recited in claim 1, wherein at least one of the splitter nodes is an asymmetric splitter node.

5. The device as recited in claim 1, wherein the active optical switch comprises a microfluidic optical switch.

6. The device as recited in claim 1, wherein the active optical switch is activatable among three or more switching states.

7. The device as recited in claim 6, wherein the active optical switch is a microfluidic optical switch and comprises
a first switch waveguide, a second switch waveguide and a coupling region formed between the first and second switch waveguides for coupling light between the first and second switch waveguides, and
one or more microfluidic droplets controllably movable relative to the coupling region to change the amount of light couplable between the first and second switch waveguides.

8. The device as recited in claim 7, wherein the one or more microfluidic droplets are controllably movable in a direction substantially perpendicular to one of the first and second switch waveguides in the coupling region.

9. The device as recited in claim 7, wherein the one or more microfluidic droplets are controllably movable in a direction substantially parallel to one of the first and second switch waveguides in the coupling region.

10. The device as recited in claim 7, wherein the one or more microfluidic droplets includes a first droplet associated with coupling a first fraction of light between the first and second switch waveguides and a second droplet associated with coupling a second fraction of light between the first and second waveguides, the first fraction being different from the second fraction.

11. The device as recited in claim 7, wherein the plurality of microfluidic droplets includes at least a first droplet controllably movable relative to the coupling region independently of other droplets of the plurality of microfluidic droplets.

12. The device as recited in claim 7, wherein the microfluidic switch is a wavelength-dependent microfluidic switch capable of coupling of a relatively large amount of light at a first wavelength between the first and second switch waveguides while coupling a relatively small amount of light at a second wavelength between the first and second switch waveguides.

13. The device as recited in claim 1, wherein first and second optical switches are serially disposed on an output waveguide from one of the splitter nodes, the first optical switch comprising a first coupling region formed between the output waveguide and a second waveguide and the second optical switch comprising a second coupling region formed between the output waveguide and a third waveguide.

14. The device as recited in claim 1, wherein the waveguide splitter cascade is formed on a first substrate and the active optical switch has a second output on a second substrate.

15. The device as recited in claim 1, wherein the active optical switch persists in a selected state without application of an active control signal.

16. An active optical switch device, comprising:
a first switch waveguide;
a second switch waveguide and a coupling region formed between the first and second switch waveguides for coupling light between the first and second switch waveguides, and
one or more microfluidic droplets controllably movable relative to the coupling region to change the amount of light couplable between the first and second switch waveguides;
wherein a first configuration of the one or more microfluidic droplets corresponds to a minimum level of optical coupling between the first and second switch waveguides, a second configuration of the one or more microfluidic droplets corresponds to a maximum level of optical coupling between the first and second switch waveguides and at least a third configuration of the one or more microfluidic droplets corresponds to at least an intermediate level of optical coupling between the first and second switch waveguides.

17. The device as recited in claim 16, wherein the one or more microfluidic droplets are controllably movable in a direction substantially perpendicular to one of the first and second switch waveguides in the coupling region.

18. The device as recited in claim 16, wherein the one or more microfluidic droplets are controllably movable in a direction substantially parallel to one of the first and second switch waveguides in the coupling region.

19. The device as recited in claim 16, wherein the one or more microfluidic droplets includes a first droplet associated with coupling a first fraction of light between the first and second switch waveguides and a second droplet associated with coupling a second fraction of light between the first and second waveguides, the first fraction being different from the second fraction.

20. The device as recited in claim 16, wherein the one or more microfluidic droplets includes at least a first droplet controllably movable relative to the coupling region independently of other droplets of the one or more microfluidic droplets.

21. The device as recited in claim 16, wherein the one or more microfluidic droplets includes particles moved by magnetic force.

22. The device as recited in claim 16, wherein the one or more microfluidic droplets includes particles moved by one of electrostatic force and hydrostatic force.

23. The device as recited in claim 16, wherein the one or more microfluidic droplets are moved substantially simultaneously to effect a change in optical coupling between the first and second switch waveguides.

24. The device as recited in claim 16, wherein a first droplet of the one or more microfluidic droplets is formed of a material having a first refractive index and a second droplet of the plurality of microfluidic droplets is formed of a material having a second refractive index different from the first refractive index.

25. The device as recited in claim 24, wherein a third droplet of the one or more microfluidic droplets is formed of a material having a third refractive index different from the first refractive index and from the second refractive index.

26. The device as recited in claim 16, wherein the first switch waveguide is on a first substrate, and the one or more microfluidic droplets are controllably movable in a direction substantially perpendicular to the first substrate.

27. The device as recited in claim 16, wherein the first switch waveguide is supported on a first substrate and the second switch waveguide is supported on a second substrate.

28. The device as recited in claim 27, wherein the first substrate comprises a first optical circuit coupled to receive light from the first switch waveguide and the second substrate comprises a second optical circuit coupled to receive light from the second switch waveguide.

29. The device as recited in claim 16, wherein the one or more microfluidic droplets are capable of coupling of a relatively large amount of light at a first wavelength between the first and second switch waveguides while coupling a relatively small amount of light at a second wavelength between the first and second switch waveguides.

30. An active optical switch device, comprising:
a first switch waveguide supported on a first substrate, the first substrate having a first optical circuit;
a second switch waveguide supported on a second substrate, the second substrate having a second optical circuit, a coupling region being formed between the first and second switch waveguides for coupling light between the first and second switch waveguides, and
one or more microfluidic droplets controllably movable relative to the coupling region to change the amount of light couplable between the first and second switch waveguides.

31. A device as recited in claim 30, wherein in a first configuration of the one or more microfluidic droplets corresponds to a minimum level of optical coupling between the first and second switch waveguides, a second configuration of the one or more microfluidic droplets corresponds to a maximum level of optical coupling between the first and second switch waveguides and at least a third configuration of the one or more microfluidic droplets corresponds to at least an intermediate level of optical coupling between the first and second switch waveguides.

32. The device as recited in claim 30, wherein the one or more microfluidic droplets are controllably movable in a direction substantially perpendicular to one of the first and second switch waveguides in the coupling region.

33. The device as recited in claim 30, wherein the one or more microfluidic droplets are controllably movable in a direction substantially parallel to one of the first and second switch waveguides in the coupling region.

34. The device as recited in claim 30, wherein the one or more microfluidic droplets includes a first droplet associated with coupling a first fraction of light between the first and second switch waveguides and a second droplet associated with coupling a second fraction of light between the first and second waveguides, the first fraction being different from the second fraction.

35. The device as recited in claim 30, wherein the one or more microfluidic droplets includes at least a first droplet controllably movable relative to the coupling region independently of other droplets of the one or more microfluidic droplets.

36. The device as recited in claim 30, wherein droplets of the one or more microfluidic droplets are moved substantially simultaneously to effect a change in optical coupling between the first and second switch waveguides.

37. The device as recited in claim 30, wherein a first droplet of the one or more microfluidic droplets is formed of a material having a first refractive index and a second droplet of the one or more microfluidic droplets is formed of a material having a second refractive index different from the first refractive index.

38. The device as recited in claim 30, wherein the one or more microfluidic droplets are controllably movable in a direction substantially perpendicular to the first substrate.

39. The device as recited in claim 30, wherein at least one of the first and second optical circuits comprises an active optical switch.

40. The device as recited in claim 30, wherein the one or more microfluidic droplets are capable of coupling of a relatively large amount of light at a first wavelength between the first and second switch waveguides while coupling a relatively small amount of light at a second wavelength between the first and second switch waveguides.

41. An optical device, comprising
a first active optical switch comprising a first waveguide and a second waveguide, a first coupling region formed between the first and second waveguides for coupling light between the first and second waveguides and at least one microfluidic droplet controllably movable relative to the first coupling region;
a second active optical switch comprising the first waveguide and a third waveguide, a second coupling region formed between the first and third waveguides for coupling light between the first and third waveguides and at least one microfluidic droplet controllably movable relative to the second coupling region; and
a third active optical switch comprising the second waveguide and a fourth waveguide, a third coupling region formed between the second and fourth waveguides for coupling light between the second and fourth waveguides and at least one microfluidic droplet controllably movable relative to the third coupling region.

42. The device as recited in claim 41, further comprising at least one splitter node coupled to receive light from one of the first, second, third and fourth waveguides.

43. The device as recited in claim 41, wherein at least one of the first, second and third active optical switches is activatable among three or more switching states.

44. The device as recited in claim 41, wherein at least one of i) the at least one microfluidic droplet of the first active optical switch, ii) the at least one microfluidic droplet of the second active optical switch and iii) the at least one microfluidic droplet of the third active optical switch includes a first droplet associated with coupling a first fraction of light at a respective coupling region and a second droplet associated with coupling a second fraction of light at the respective coupling region, the first fraction being different from the second fraction.

45. The device as recited in claim 41, wherein at least one of i) the at least one microfluidic droplet of the first active optical switch, ii) the at least one microfluidic droplet of the second active optical switch and iii) the at least one microfluidic droplet of the third active optical switch includes at least a first droplet controllably movable relative to the coupling region independently of other droplets of the at least one microfluidic droplet.

46. The device as recited in claim 41, further comprising a fourth active optical switch formed at a coupling region between one of the first, second, third and fourth waveguides and a fifth waveguide.

47. The device as recited in claim 41, wherein one of the first, second and third coupling regions is formed between a waveguide on a first substrate and another waveguide on a second substrate.

48. The device as recited in claim 41, wherein at least one of i) the at least one microfluidic droplet of the first active optical switch, ii) the at least one microfluidic droplet of the second active optical switch and iii) the at least one microfluidic droplet of the third active optical switch is capable of coupling of a relatively large amount of light at a first wavelength between waveguides while coupling a relatively small amount of light at a second wavelength between waveguides.

49. An end user optical transceiver device, comprising:
an input waveguide coupled to receive optical data transmitted from a fiber distribution hub;
a transceiver unit coupled to receive an optical signal from the input waveguide;
a second waveguide coupled to a waveguide reflector that reflects light at a wavelength of light received at the input waveguide; and
an optical switch at a coupling region between the input and second waveguides to selectively switch light from the input waveguide to the waveguide reflector.

50. The device as recited in claim 49, wherein when the optical switch is activated to switch light from the input waveguide to the second waveguide essentially no optical signal reaches the transceiver unit.

51. The device as recited in claim 49, wherein the optical switch persists in a selected switching state without the application of an active control signal.

52. The device as recited in claim 49, wherein the optical switch comprises a microfluidic optical switch.

53. The device as recited in claim 49, wherein the active optical switch is activatable among three or more switching states.

54. The device as recited in claim 49, wherein the optical switch is a microfluidic optical switch and comprises one or more microfluidic droplets controllably movable relative to the coupling region to change the amount of light couplable between the input and second switch waveguides.

55. The device as recited in claim 54, wherein the one or more microfluidic droplets are controllably movable in a direction substantially perpendicular to one of the input and second waveguides in the coupling region.

56. The device as recited in claim 54, wherein the one or more microfluidic droplets are controllably movable in a direction substantially parallel to one of the input and second switch waveguides in the coupling region.

57. The device as recited in claim 54, wherein the one or more microfluidic droplets are capable of coupling of a relatively large amount of light at a first wavelength between the input waveguide and the second waveguide while coupling a relatively small amount of light at a second wavelength between the input waveguide and the second waveguide.

58. A switchable wavelength-dependent optical device, comprising:
a first waveguide couplable to receive an optical signal at at least a first wavelength and a second wavelength;
a wavelength selective reflector on the first waveguide that transmits light within the first waveguide at the first wavelength, in a first reflective state, reflects light within the waveguide at the second wavelength, and in a second reflective state transmits light within the waveguide at the second wavelength; and
a microfluidic arrangement configured to control the reflective state of the wavelength selective reflector.

59. The device as recited in claim 58, wherein the microfluidic arrangement comprises one or more microfluidic droplets controllably movable relative to the wavelength selective reflector to change the reflective state of the wavelength selective reflector.

60. The device as recited in claim 58, wherein the wavelength selective reflector persists in a selected reflective state without continuing application of a control signal to the microfluidic arrangement.

61. The device as recited in claim 58, wherein the wavelength selective reflector comprises a grating in the first waveguide, the first waveguide having a refractive index of n₁, the grating being formed with repeated regions having a refractive index n₂, and the microfluidic arrangement comprises ducts coupling between a fluid reservoir and the repeated regions so that fluid can controllably flow into the repeated regions to change a reflective state of the wavelength selective reflector.

62. The device as recited in claim 58, further comprising a transceiver coupled to receive the optical signal from the first waveguide.
